(19) United States
(12) Patent Application Publication
(10) Pub. No.: US 2002/0038216 A1
(43) Pub. Date: Mar. 28, 2002

(54) Compression data recording apparatus, recording method, compression data recording and reproducing apparatus, recording and reproducing method, and recording medium

(75) Inventor: Hiroshi Suzuki, Saitama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, Shinagawa-Ku (JP)

(21) Appl. No.: 09/951,452

(22) Filed: Sep. 14, 2001

(30) Foreign Application Priority Data
Sep. 14, 2000 (JP) 2000-280409

(51) Int. Cl. G10L 19/00

(52) U.S. Cl. 704/500

(57) ABSTRACT

An ATC encoder 63 to which an analog audio input signal Ain is supplied through an input terminal 60, an LPF 61, and an A/D converter 62 or a digital audio input signal Din is supplied through an input terminal 67 performs a bit compressing process with respect to digital audio PCM data of a predetermined transfer speed obtained by quantizing the input signal Ain by the A/D converter 62. A memory 64 is used as a buffer memory for temporarily storing ATC data supplied from the ATC encoder 63 and recording it onto a disc as necessary. The ATC audio data read out at a transfer speed of 75 sectors/sec in a burst manner from the memory 64, that is, the recording data is supplied to an encoder 65. The encoder 65 executes a coding process, an EFM coding process, or the like for error correction with respect to the recording data supplied from the memory 64 in a bust manner. It is possible to cope with compression ratios and compression/decompression qualities in a wider range and it is possible to easily cope with a case of recording the data onto recording media whose recording capacities (densities) are largely different or a case of transmitting the data by using transmission lines whose transmission capacities are different. The compression ratio and compression/decompression quality can be selected in accordance with convenience of a signal compressing and decompressing apparatus or information compressing and decompressing method.

### BACKGROUND OF THE INVENTION

1. Field of the Invention

The invention relates to a recording and a reproduction of compression data obtained by bit-compressing a digital audio signal or the like, a recording medium on which the compression data is recorded, and a transmission system of the compression data. More particularly, the invention relates to a compression data recording apparatus, a recording method, a compression data recording and reproducing apparatus, a recording and reproducing method, and a recording medium, in which a digital signal is information-compressed and recorded or transmitted and/or reproduced or received and decompressed so as to change a frequency-like size of small blocks which were finely divided by a time and a frequency for performing a floating for information compression and/or performing bit distribution for compression in accordance with a change in input signal on a frequency base.

2. Description of the Related Arts

The applicant of the present invention has already proposed the techniques for bit-compressing an inputted digital audio signal and recording the compressed signal in a burst-like manner by setting a predetermined data amount to a recording unit, for example, in the specification, drawings, and the like of each of Japanese Patent Application Nos. 2-221364, 2-221365, 2-222821, and 2-222823.

According to those techniques, a magnetooptic disc is used as a recording medium and AD (adaptive differential) PCM audio data specified in an audio data format of what is called CD-I (CD-Interactive), CD-ROM, or XA is recorded and reproduced. The data corresponding to, for example, 32 sectors of the ADPCM data and the data corresponding to a few sectors for linking for an interleaving process are set to a recording unit and recorded onto the magnetooptic disc in a burst-like manner.

Several modes can be selected for the ADPCM audio in a recording and reproducing apparatus using the magnetooptic disc. For example, as compared with a reproducing time of an ordinary CD (CD: compact disc), a level A in which a compression ratio is set to two times and a sampling frequency is equal to 37.8 kHz, a level B in which a compression ratio is set to four times and a sampling frequency is equal to 37.8 kHz, and a level C in which a compression ratio is set to eight times and a sampling frequency is equal to 18.9 kHz are specified. That is, for example, in case of the level B, digital audio data is compressed into almost ¼ and a reproducing time (playtime) of the disc recorded in the mode of the level B is 4 times as long as that of a standard CD format (CD-DA: (compact disc digital audio) format). According to this level, since a recording/reproducing time which is almost equal to that of a standard disc having a diameter of 12 cm can be obtained by a disc smaller than the standard disc, the apparatus can be miniaturized.

Since a rotational speed of the disc is the same as that of the standard CD, however, for example, in case of the level B, compression data corresponding to the play time of four times per predetermined time can be obtained. Therefore, the same compression data is read out four times in an overlapping manner on a time unit basis of a sector, a cluster, or the like and only the compression data corresponding to one time in the read-out compression data of four times is used for audio reproduction. Specifically speaking, when a spiral recording track is scanned (tracking), the reproducing operation is executed in a mode such as to perform a track jump such that a light spot for reading is returned to an original track position every rotation and repetitively scan (track) the same track every four times. This means that it is sufficient to obtain the normal compression data at least only once among the overlap reading operations of, for example, 4 times. Such a method is strong against errors which are caused by a disturbance or the like and suitable when it is applied to, particularly, a portable small apparatus.

The applicant of the present invention further has proposed the bit allocating method for efficiently realizing good compression in the specification, drawings, and the like of Japanese Patent Application No. 4-36952. According to such a technique, upon allocation of the bits, a normalization, that is, what is called a block floating is performed by a representative value in each small block such as so-called a critical band, a bit allocation depending on a size of signal in each small block is executed while applying a weight thereto in accordance with the corresponding band of the small block. According to such a technique, when an extreme variation does not occur in a size of spectrum in each small block, the compression can be preferably performed.

In addition, the applicant of the present invention further has proposed the method whereby an information decompressing apparatus is provided in a part of a digital signal information compressing apparatus and a bit allocation is performed so as to minimize errors at the time of information decompression for reproduction in the specification, drawings, and the like of Japanese Patent Application No. 05-050545.

However, in case of performing the compression and decompression of digital audio data by applying the above techniques, those techniques are generally constructed and adjusted for the purpose of obtaining a compression ratio (bit rate) in a certain specific range and compression/decompression quality. Therefore, in case of recording data onto recording media whose recording capacities (densities) are largely different or in case of transmitting data by using transmission lines whose transmission capacities are largely different, it is necessary to form a plurality of compression bit streams on the basis of a compression ratio according to the capacity and target quality.

According to the above techniques, furthermore, when the compression ratios are largely different, a situation such that the data cannot be efficiently compressed occurs or since it is necessary to use a plurality of signal compressing apparatuses or information compressing methods in order to efficiently cope with the compression ratios which are largely different, there is a tendency such that the apparatus becomes complicated.

In addition, in case of decompressing a bit stream compressed by the signal compressing apparatuses or information compressing method, there is a case where it is difficult to select a method of reducing a load for decompression, for example, a method of reducing the load for decompression by deteriorating decompression quality in a portable decompressing apparatus, or the like in dependence on circumstances of a signal decompressing apparatuses or an information decompressing method.

### OBJECTS AND SUMMARY OF THE INVENTION

The invention is made in consideration of the above circumstances and it is an object of the invention to provide a compression data recording apparatus, a recording method, a compression data recording and reproducing apparatus, a recording and reproducing method, and a recording medium, in which by combining fundamental signal compressing apparatuses or information compressing methods of a small scale in a layer manner, it is possible to cope with compression ratios and compression/decompression quality in a wider range, it is possible to easily cope with a case of recording data onto recording media whose recording capacities (densities) are largely different or a case of transmitting data by using transmission lines whose transmission capacities are different, and the compression ratio and compression/decompression quality can be selected in accordance with circumstances of a signal compressing and decompressing apparatus or an information compressing and decompressing method.

According to the first aspect of the invention, there is provided a compression data recording apparatus for compressing a digital signal, comprising: band dividing means for dividing an input signal into a plurality of bands; and compressing and decompressing means for performing a compression and a decompression of a small scale for compressing and decompressing the divided bands, wherein the compressing and decompressing means is arranged at a plurality of stages in a layer manner.

According to the second aspect of the invention, there is provided a compression data recording apparatus for compressing a digital signal, comprising: error detecting means for detecting an error of a compression result in a compression processing step; and recompressing means for recompressing the error, wherein data in which the error was recompressed is added, thereby improving compression quality.

According to the third aspect of the invention, there is provided a compression data recording apparatus for compressing a digital signal, comprising: recording means for divisionally recording compression data in a layer manner; and selective recording means for selectively recording a whole or a part of the data upon recording, wherein quality upon decompression of the compression data which is recorded can be selected and controlled.

According to the fourth aspect of the invention, there is provided a compression data recording and reproducing apparatus for decompressing compression data in which a digital signal has been compressed, comprising: recording means for divisionally recording the compression data in a layer manner; and selective decompressing means for selectively decompressing a whole or a part of the data upon decompression, wherein decompression quality can be selected upon decompression.

According to the fifth aspect of the invention, there is provided a compression data recording method of compressing a digital signal, comprising the steps of: dividing an input signal into a plurality of bands; performing a compression and a decompression of a small scale for compressing and decompressing the divided bands; and

arranging the step of performing the compression and decompression of the small scale at a plurality of stages in a layer manner.

According to the sixth aspect of the invention, there is provided a compression data recording method of compressing a digital signal, comprising the steps of: detecting an error of a compression result in a compression processing step; recompressing the error; and adding data in which the error was recompressed, thereby improving compression quality.

According to the seventh aspect of the invention, there is provided a compression data recording method of compressing a digital signal, comprising the steps of: divisionally recording compression data in a layer manner; selectively recording a whole or a part of the data upon recording; and enabling quality upon decompression of the compression data which is recorded to be selected and controlled.

According to the eighth aspect of the invention, there is provided a compression data recording and reproducing method of decompressing compression data in which a digital signal has been compressed, comprising the steps of: divisionally recording the compression data in a layer manner; selectively decompressing a whole or a part of the data upon decompression; and enabling decompression quality to be selected upon decompression.

According to the ninth aspect of the invention, there is provided a recording medium for recording compression data in which a digital signal has been compressed, wherein an input signal is divided into a plurality of bands and a step of performing a compression and a decompression of a small scale for compressing and decompressing the divided bands is arranged at a plurality of stages in a layer manner, thereby recording the formed compression data.

According to the tenth aspect of the invention, there is provided a recording medium for recording compression data in which a digital signal has been compressed, wherein an error of a compression result in a compression processing step is detected, the error is recompressed, and data in which the error was recompressed is added, thereby recording the formed compression data.

According to the eleventh aspect of the invention, there is provided a recording medium for recording compression data in which a digital signal has been compressed, wherein the compression data is divisionally recorded in a layer manner and a whole or a part of the data is selectively recorded upon recording, thereby recording the formed compression data.

According to the twelfth aspect of the invention, there is provided a recording medium on which compression data in which a digital signal has been compressed is recorded and the recorded compression data is decompressed, wherein the compression data is divisionally recorded in a layer manner upon compression, and the formed compression data is recorded and reproduced so that a whole or a part of the data can be selectively decompressed upon decompression.

According to the invention, it is possible to efficiently cope with a compression ratio in a wide range by the single apparatus or information compressing method. The information of a wider band and higher precision can be compressed by the combination of a plurality of signal processing circuits of a smaller scale. By forming the bit stream adapted to the combination of the signal processing circuits of the small scale, for example, in the apparatus in which importance is attached to the portability, a part of the compressed data can be selectively decompressed and reproduced in the same compression bit stream. In the apparatus which is fixedly installed, the signal of higher quality can be compressed, decompressed, or the like in the same compression bit stream. The quality upon decompression and reproduction can be selected more flexibly in case of compressing the data in a wider range as compared with the case in the conventional apparatus and can be also easily selected in the decompressing apparatus.

Moreover, according to the invention, since the compressed bit stream itself corresponds to a plurality of bit rates, it is possible to cope with the transmission of the information by the transmission paths having various transfer rate is and the recording to the recording media having different recording capacities (densities) by the same compression bit stream.

The above and other objects and features of the present invention will become apparent from the following detailed description and the appended claims with reference to the accompanying drawings.

### BRIEF DESCRIPTION OF THE DRAWINGS

FIG. 1 is a block circuit diagram showing an example of a construction of a recording and reproducing apparatus (disc recording and reproducing apparatus) of compression data according to an embodiment of a digital signal processing apparatus of the invention;

FIG. 2 is a block circuit diagram showing a specific example of a high efficient compression encoder which can be used for a bit rate compression encoding of the embodiment;

FIG. 3 is a block circuit diagram showing a specific example of a fundamental encoder which can be used for the bit rate compression encoding of the embodiment;

FIGS. 4A to 4C are graphs showing a decompression result in the ease where a gain control is not performed in the embodiment;

FIGS. 5A to 5E are graphs showing a decompression result and an effect in the case where the gain control is performed in the embodiment;

11

FIG. 6 is a block circuit diagram showing an example of a bit distribution calculating circuit using a convolutional arithmetic operation to realize a bit distribution arithmetic operating function;

FIG. 7 is a graph showing a spectrum of bands divided in consideration of each critical band and a block floating;

FIG. 8 is a graph showing a masking spectrum;

FIG. 9 is a graph obtained by synthesizing a minimum audible curve and the masking spectrum;

FIG. 10 is a block circuit diagram showing a specific example of an expansion encoder which can be used for the bit rate compression encoding of the embodiment;

FIG. 11 is a block circuit diagram showing a specific example of a high efficient compression encoding decoder which can be used for a bit rate compression encoding of the embodiment;

FIG. 12 is a block circuit diagram showing a specific example of a fundamental decoder which can be used for the bit rate compression encoding of the embodiment;

FIG. 13 is a diagram showing a specific example of a compression bit stream of the embodiment;

FIG. 14 is a diagram showing a concept in the case where only a fundamental band was decompressed in the embodiment;

FIG. 15 is a diagram showing a concept in the case where the fundamental band and a fundamental band expanding unit were decompressed in the embodiment;

FIG. 16 is a diagram showing a concept in the case where the fundamental band, the fundamental band expanding unit, and a ×2 band were decompressed in the embodiment;

FIG. 17 is a diagram showing a concept in the case where the fundamental band, the fundamental band expanding unit, the ×2 band, and a ×2 band expanding unit were decompressed in the embodiment;

FIG. 18 is a diagram showing a Goncept in the case where the fundamental band, the fundamental band expanding unit, the ×2 band, the ×2 band expanding unit, and a ×3 band were decompressed in the embodiment;

FIG. 19 is a diagram showing a concept in the case where the fundamental band, the fundamental band expanding unit, the ×2 band, the ×2 band expanding unit, the ×3 band, and a ×3 band expanding unit were decompressed in the embodiment;

FIG. 20 is a diagram showing a concept in the case where the fundamental band, the fundamental band expanding unit, the ×2 band, the ×2 band expanding unit, the ×3 band, the ×3 band expanding unit, and a ×4 band were decompressed in the embodiment;

FIG. 21 is a diagram showing a concept in the case where the fundamental band, the fundamental band expanding unit, the ×2 band, the ×3 band, and the ×4 band were decompressed in the embodiment;

FIG. 22 is a diagram showing a concept in the case where the fundamental band, the fundamental band expanding unit, the ×2 band, the ×2 band expanding unit, the ×3 band, and the ×4 band were decompressed in the embodiment;

FIG. 23 is a diagram showing a concept in the case where the fundamental band, the fundamental band expanding unit, the ×2 band, and the ×3 band were decompressed in the embodiment;

FIG. 24 is a diagram showing a concept in the case where streams of all word lengths and frequency bands have been recorded onto the same track on a recording medium in the embodiment;

FIG. 25 is a diagram showing a concept in the case where the streams have been recorded onto different tracks on the recording medium every all word lengths and frequency bands in the embodiment; and

FIG. 26 is a diagram showing a concept in the case where the streams have been recorded onto different tracks on the recording medium every all frequency bands in the embodiment.

### DETAILED DESCRIPTION OF THE PREFERRED EMBODIMENT

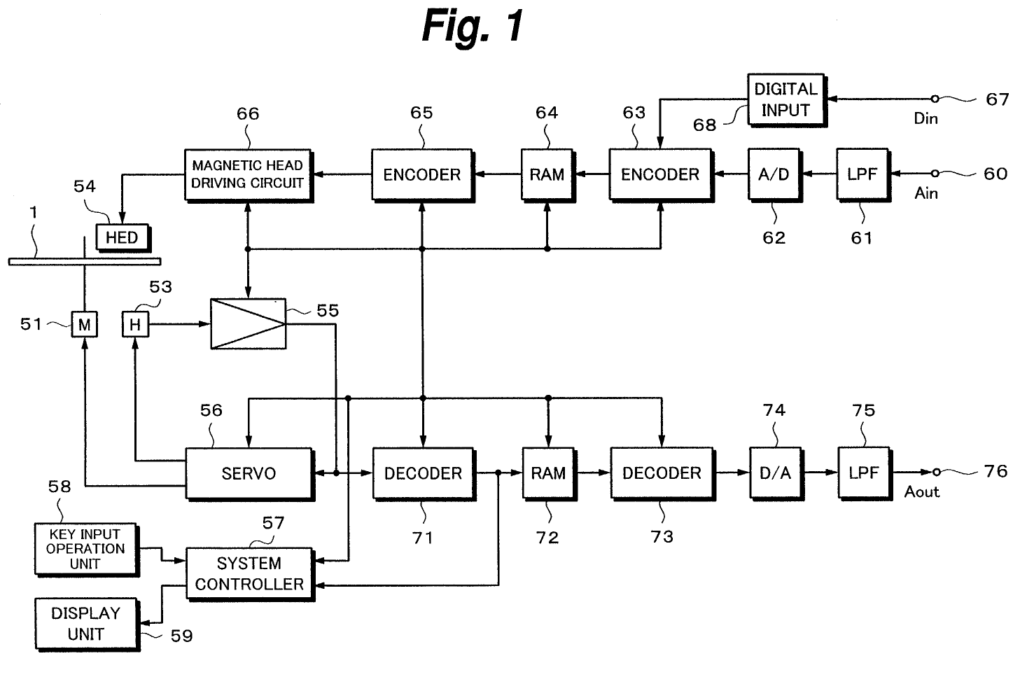

First, FIG. 1 is a block circuit diagram showing a schematic construction of an embodiment of a digital signal processing apparatus (compression data recording and reproducing apparatus) of the invention.

In the compression data recording and reproducing apparatus shown in FIG. 1, first, a magnetooptic disc 1 which is rotated by a spindle motor 51 is used as a recording medium. When data is recorded onto the magnetooptic disc 1, for example, in a state where a laser beam has been irradiated by an optical head 53, a modulation magnetic field according to the recording data is applied by a magnetic head 54, thereby performing what is called a magnetic field modulation recording and recording the data along a recording track on the magnetooptic disc 1. Upon reproduction, the recording track on the magnetooptic disc 1 is traced by the laser beam by the optical head 53, thereby magnetooptically reproducing the data.

The optical head 53 comprises: for example, a laser light source such as a laser diode or the like; optical parts such as collimator lens, objective lens, polarization beam splitter, cylindrical lens, and the like; a photodetector having a photosensing unit of a predetermined pattern; and the like. The optical head 53 is arranged at a position which faces the magnetic head 54 so as to sandwich the magnetooptic disc 1. When the data is recorded onto the magnetooptic disc 1, the magnetic head 54 is driven by a magnetic head driving circuit 66 of a recording system, which will be explained hereinlater, a modulation magnetic field according to the recording data is applied, and the laser beam is irradiated onto a target track on the magnetooptic disc 1 by the optical head 53, thereby performing a thermal magnetic recording by a magnetic field modulation system. The optical head 53 detects the reflection light of the laser beam irradiated onto the target track, detects a focusing error by, for example, what is called an astigmatism aberration method, and detects a tracking error by, for example, what is called a push-pull method. When the data is reproduced from the magnetooptic disc 1, the optical head 53 detects the focusing error and the tracking error and detects a difference of a polarization angle (Kerr rotational angle) of the reflection light from the target track of the laser beam, thereby forming a reproduction signal.

An output of the optical head 53 is supplied to an RF circuit 55. The RF circuit 55 extracts a focusing error signal and a tracking error signal from the output of the optical head 53, supplies them to a servo control circuit 56, binarizes the reproduction signal, and supplies it to a decoder 71 of a reproducing system, which will be explained hereinlater.

The servo control circuit 56 comprises: for example, a focusing servo control circuit; a tracking servo control circuit; a spindle motor servo control circuit; a thread servo control circuit; and the like. The focusing servo control circuit performs a focusing control of the optical system of the optical head 53 so as to set the focusing error signal to zero. The tracking servo control circuit performs a tracking control of the optical system of the optical head 53 so as to set the tracking error signal to zero. The spindle motor servo control circuit further controls the spindle motor 51 so as to rotate the magnetooptic disc 1 at a predetermined rotational speed (for example, constant linear velocity). The thread servo control circuit moves the optical head 53 and magnetic head 54 to the target track position on the magnetooptic disc 1 which is designated by a system controller 57. The servo control circuit 56 for performing such various control operations sends information indicative of an operating state of each unit which is controlled by the servo control circuit 56 to the system controller 57.

A key input operation unit 58 and a display unit 59 are connected to the system controller 57. The system controller 57 controls the recording system and the reproducing system in an operating mode which is designated by operation input information which is inputted by the key input operation unit 58. On the basis of a header time which is obtained from the recording track on the magnetooptic disc 1 and address information of a sector unit which is reproduced by Q data of a subcode or the like, the system controller 57 manages a recording position and a reproducing position on the recording track which is being traced by the optical head 53 and magnetic head 54. Further, the system controller 57 controls the display unit 59 so as to display a reproducing time on the basis of a data compression ratio and the information indicative of the reproducing position on the recording track.

With respect to the display of the reproducing time, the address information (absolute time information) of the sector unit which is reproduced by a header time, what is called a subcode Q data, and the like from the recording track on the magnetooptic disc 1 is multiplied by a reciprocal number (for example, 8 in case of ⅛ compression) of the data compression ratio, thereby obtaining actual time information and displaying it onto the display unit 59. Also upon recording, for example, in the case where the absolute time information has previously been recorded (preformatted) on the recording track on the magnetooptic disc or the like, by reading the preformatted absolute time information and multiplying the reciprocal number of the data compression ratio, the present position can be also displayed by the actual recording time.

Subsequently, in the recording system of the recording and reproducing apparatus of the disc recording and reproducing apparatus, an analog audio input signal A in from an input terminal 60 is supplied to an A/D converter 62 through a low pass filter 61. The A/D converter 62 quantizes the analog audio input signal A in. A digital audio signal obtained from the A/D converter 62 is supplied to an ATC (Adaptive Transform Coding) encoder 63. A digital audio input signal Din from an input terminal 67 is supplied to the ATC encoder 63 through a digital input interface circuit 68. The ATC encoder 63 executes a bit compressing (data compressing) process with respect to digital audio PCM data of a predetermined transfer speed obtained by quantizing the input signal Ain by the A/D converter 62.

In the embodiment, an information amount of the digital audio PCM data will be explained on the assumption that a sampling frequency is equal to 176.4 kHz, a quantization word length is equal to 24 bits, and a compression ratio in the signal process is equal to 1/12 time. However, the embodiment has a construction which does not depend on the information amount of the digital audio PCM data and the compression ratio. Those values can be arbitrarily selected in accordance with an application example.

A memory 64 is used as a buffer memory in which the writing and reading operations of data are controlled by the system controller 57 and which is used for temporarily storing ATC data that is supplied from the ATC encoder 63 and recording it onto the disc as necessary. That is, for example, as for the compression audio data which is supplied from the ATC encoder 63, its data transfer speed is reduced to ½ of a data transfer speed (75 sectors/sec) of the standard CD-DA format, that is, to 37.5 sectors/sec. The compression data is continuously written into the memory 64. In case of the compression data (ATC data), although it is sufficient to perform the recording of one sector per two sectors as mentioned above, since such a recording which is executed every third sector is actually impossible, a sector-continuous recording as will be explained hereinlater, is executed. This recording is executed in a burst manner at the same data transfer speed (75 sectors/sec) as that of the standard CD-DA format through a pause period by setting a cluster comprising a predetermined plurality of sectors (for example, 32 sectors+a few sectors) to a recording unit. That is, in the memory 64, the ATC audio data continuously written at a low transfer speed of 37.5 (=75/2) sectors/sec according to a bit compression rate is read out as recording data in a burst manner at the transfer speed of 75 sectors/sec. With respect to the data which is read out and recorded, although the overall data transfer speed including the recording pause period is equal to the low speed of 37.5 sectors/sec, an instantaneous data transfer speed within the time of the recording operation which is executed in a burst manner is equal to the standard speed of 75 sectors/sec. Therefore, when a rotational speed of the disc is equal to the same speed (constant linear velocity) as that in the standard CD-DA format, the recording of the same recording density and storage pattern as those in the CD-DA format is executed.

The ATC audio data read out from the memory 64 at a (instantaneous) transfer speed of 75 sectors/sec in a burst manner, that is, the recording data is supplied to an encoder 65. In a data train which is supplied from the memory 64 to the encoder 65 here, a unit which is continuously recorded per recording operation is set to the cluster comprising a plurality of sectors (for example, 32 sectors) and a few sectors for cluster connection arranged at the positions before and after the cluster. The sectors for cluster connection are set to a length longer than an interleave length in the encoder 65, thereby preventing data of another cluster from being influenced even if they are interleaved.

The encoder 65 performs an encoding process (parity adding and interleaving process) for error correction, an EFM encoding process, and the like with respect to the recording data which is supplied from the memory 64 in a burst manner as mentioned above. The recording data subjected to the encoding process by the encoder 65 is supplied to the magnetic head driving circuit 66. The magnetic head 54 is connected to the magnetic head driving circuit 66. The magnetic head driving circuit 66 drives the magnetic head 54 so as to apply a modulation magnetic field according to the recording data to the magnetooptic disc 1.

The system controller 57 performs a memory control to the memory 64 in a manner as mentioned above and controls the recording position in a manner such that the recording data which is read out from the memory 64 in a burst manner by the memory control is continuously recorded onto the recording track on the magnetooptic disc 1 or selectively and discretely recorded thereon as will be explained hereinlater. The control of the recording position is performed by a method whereby the recording position of the recording data which is read out from the memory 64 in a burst manner is managed by the system controller 57 and a control signal to designate the recording position on the recording track on the magnetooptic disc 1 is supplied to the servo control circuit 56.

Subsequently, the reproducing system of the magnetooptic disc recording and reproducing unit will be described. The reproducing system reproduces the recording data recorded continuously on the recording track on the magnetooptic disc 1 by the foregoing recording system and has the decoder 71. A reproduction output which is obtained by tracing the recording track on the magnetooptic disc 1 by the laser beam by the optical head 53 is binarized by the RF circuit 55 and supplied to the decoder 71. At this time, not only the magnetooptic disc but also the same read only optical disc as the compact disc (CD) can be read out.

The decoder 71 corresponds to the encoder 65 in the foregoing recording system. The decoder 71 executes processes such as decoding process, EFM decoding process, and the like for error correction as mentioned above with respect to the reproduction output binarized by the RF circuit 55, and reproduces the audio data at a transfer speed of 75 sectors/sec faster than the normal transfer speed. The reproduction data obtained by the decoder 71 is supplied to a memory 72.

The writing and reading operations of the data into/from the memory 72 are controlled by the system controller 57. The reproduction data which is supplied from the decoder 71 at a transfer speed of 75 sectors/sec is written at a transfer speed of 75 sectors/sec in a burst manner. From the memory 72, the reproduction data written in a burst manner at a transfer speed of 75 sectors/sec is continuously read out at 37.5 sectors/sec which is ½ of the normal transfer speed of 75 sectors/sec.

The system controller 57 performs a memory control so as to write the reproduction data into the memory 72 at a transfer speed of 75 sectors/sec and to continuously read out the reproduction data from the memory 72 at a transfer speed of 37.5 sectors/sec. The system controller 57 performs the memory control to the memory 72 as mentioned above and also controls the reproducing position in a manner such that the reproduction data which is read out from the memory 72 in a burst manner by the above memory control is continuously reproduced from the recording track on the magnetooptic disc 1. The control of the reproducing position is performed by a method whereby the reproducing position of the reproduction data which is read out from the memory 72 in a burst manner by the system controller 57 is managed and a control signal to designate the reproducing position on the recording track on the magnetooptic disc 1 or optical disc 1 is supplied to the servo control circuit 56.

The ATC audio data which is obtained as reproduction data and was continuously read out from the memory 72 at a transfer speed of 37.5 sectors/sec is supplied to an ATC decoder 73. The ATC decoder 73 reproduces the digital audio data having a quantization word length of 24 bits by decompressing (bit decompression) the ATC data by 12 times. The digital audio data from the ATC decoder 73 is supplied to a D/A converter 74.

The D/A converter 74 converts the digital audio data supplied from the ATC decoder 73 into an analog signal, thereby forming an analog audio output signal Aout. The analog audio output signal Aout obtained from the D/A converter 74 is outputted from an output terminal 76 through a low pass filter 75.

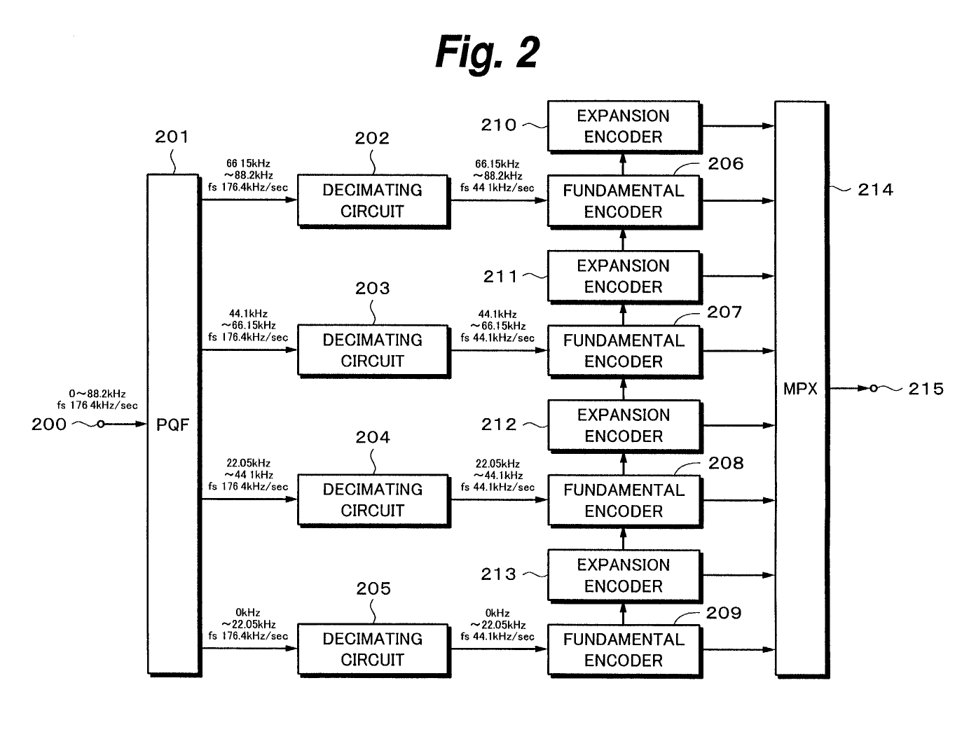

A high efficient compression encoding will now be described in detail. That is, a technique for high-efficient encoding an input digital signal such as an audio PCM signal or the like by using each technique such as separate-band coding (SBC), adaptive transform coding (ATC), adaptive bit allocation, or the like will be described with reference to FIG. 2 and subsequent drawings.

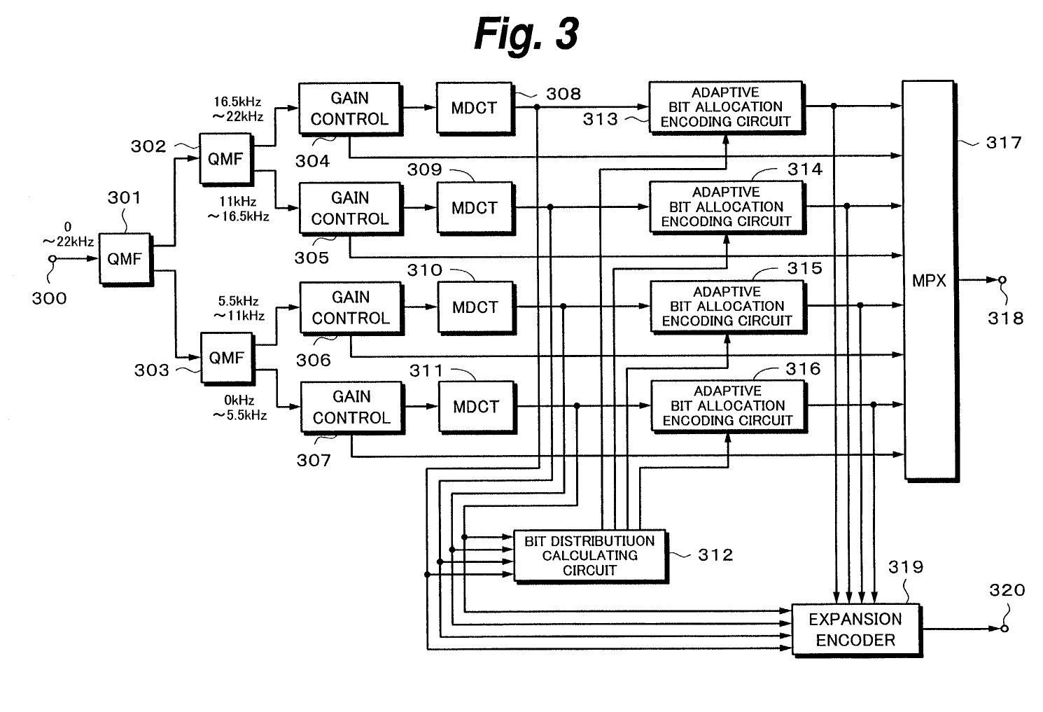

In a specific high efficient encoding apparatus shown in FIG. 3, the input digital signal is divided into a plurality of frequency bands of an equal band width and a decimating process is executed every frequency band so that an apparent sampling frequency is equal to a fraction of the division number. After that, information is compressed by a fundamental encoder for compressing the information of the fraction of the division number of the input digital signal. The information of the lowest frequency band is used as a fundamental bit stream. The information of the other frequency bands is outputted as an expansion bit stream.

That is, in FIG. 2, for example, when the quantization word length is equal to 24 bits and the sampling frequency is equal to 176.4 kHz, the audio PCM signal in a frequency range of 0 to 88.2 kHz is supplied to an input terminal 200. This input signal is divided into, for example, a frequency band of 0 to 22.05 kHz, a frequency band of 22.05 kHz to 44.1 kHz, a frequency band of 44.1 kHz to 66.15 kHz, and a frequency band of 66.15 kHz to 88.2 kHz by a PQF (Polyphase Quadrature Filter) 201 as what is called an equal band width band dividing filter. The signals of the respective bands divided by the PQF 201 are inputted to the following decimating circuits. That is, the signal of the band of 0 to 22.05 kHz is inputted to a decimating circuit 205, the signal of the band of 22.05 kHz to 44.1 kHz is inputted to a decimating circuit 204, the signal of the band of 44.1 kHz to 66.15 kHz is inputted to a decimating circuit 203, and the signal of the band of 66.15 kHz to 88.2 kHz is inputted to a decimating circuit 202, respectively.

As a method of dividing the foregoing input digital signal into the frequency bands of the equal band width, for example, there is the PQF as disclosed in Joseph H. Rothweiler, “A New Subband Coding Technique”, ICASSP 83, Boston Polyphase Quadrature Filters.

Since the frequency band width of the signal of each band inputted to the decimating circuits 202 to 205 is equal to ¼ of the audio PCM signal inputted to the input terminal 200, even if the data is decimated into ¼, the information is not lost. Therefore, each data is decimated into ¼ and inputted to the following fundamental encoders. That is, the signal of the band of 0 to 22.05 kHz is inputted to a fundamental encoder 209, the signal of the band of 22.05 kHz to 44.1 kHz is inputted to a fundamental encoder 208, the signal of the band of 44.1 kHz to 66.15 kHz is inputted to a fundamental encoder 207, and the signal of the band of 66.15 kHz to 88.2 kHz is inputted to a fundamental encoder 206, respectively.

When the data is decimated, what are called aliasing noises are generated and become a cause of disturbing the information. However, an amount of generated aliasing noises generally depends on characteristics of the band dividing filter. In the embodiment, the aliasing noises are cancelled by using the PQF and a degree of the PQF 201 is set to 96 taps, thereby obtaining a good result which is not practically influenced by the aliasing noises.

Each of the fundamental encoders 206 to 209 in FIG. 2 is an encoder having an ability of encoding an information amount of what is called a compact disc (sampling frequency of 44.1kHz, quantization word length of 16 bits). By using those four encoders, the audio PCM signal of a sampling frequency of 176.4 kHz which is inputted to the input terminal 200 in FIG. 2 can be encoded. The information outputted from the fundamental encoders 206 to 209 is inputted to an MPX (multiplexer) circuit 214, combined into one stream and outputted as an expansion bit stream from an output terminal 215.

In order to interpolate information compressing ability of the fundamental encoder and expand the information to a quantization word length of about 24 bits, a quantization error of the compression information which is outputted from the fundamental encoder 206 is outputted to an expansion encoder 210, a quantization error of the compression information which is outputted from the fundamental encoder 207 is outputted to an expansion encoder 211, a quantization error of the compression information which is outputted from the fundamental encoder 208 is outputted to an expansion encoder 212, and a quantization error of the compression information which is outputted from the fundamental encoder 209 is outputted to an expansion encoder 213, respectively. Each of the quantization errors is recompressed, requantized, outputted to the MPX circuit 214, and combined with the information outputted from the fundamental encoders 206 to 209. The resultant combined information is outputted from the output terminal 215.

FIG. 3 shows a block circuit diagram showing a schematic construction of one specific example of the fundamental encoders. In the specific encoder shown in FIG. 3, the input digital signal is divided into a plurality of frequency bands of the equal band width, an orthogonal transformation is performed every frequency band, and obtained spectrum data of a frequency base is encoded by adaptively allocating bits every what is called a critical band width (critical band) which takes into consideration human auditory characteristics, which will be explained hereinlater, in the low band and every band obtained by dividing the critical band width in consideration of block floating efficiency in the mid-high band. Ordinarily, this block becomes a quantization noise generation block. The critical band is a frequency band divided in consideration of the human auditory characteristics and is a band of noises in the case where a certain pure sound is masked by band noises of narrow bands of the same intensity near a frequency of such a certain pure sound. With respect to the critical band, a band width of a higher band is wider and the whole frequency band of 0 to 22 kHz is divided into, for example, 25 critical bands.

That is, in FIG. 3, for example, when the sampling frequency is equal to 44.1 kHz, the audio PCM signal having a frequency width of 22 kHz is supplied to an input terminal 300. This input signal is divided into a band of 0 to 11 kHz and a band of 11 to 22 kHz by a band dividing filter 301 such as what is called a QMF (Quadrature Mirror Filter) or the like. Further, the signal of band of 0 to 11 kHz is likewise divided into a band of 0 to 5.5 kHz and a band of 5.5 to 11 kHz by a band dividing filter 303 such as what is called a QMF or the like. The signal of band of 11 to 22 kHz is likewise divided into a band of 11 to 16.5 kHz and a band of 16.5 to 22 kHz by a band dividing filter 302 such as what is called a QMF or the like. The signal of band of 16.5 to 22 kHz from the band dividing filter 302 is sent to a gain control circuit 304. The signal of band of 11 to 16.5 kHz is sent to a gain control circuit 305. The signal of band of 5.5 to 11 kHz from the band dividing filter 303 is sent to again control circuit 306. The signal of band of 0 to 5.5 kHz from the band dividing filter 303 is sent to a gain control circuit 307. In each of the gain control circuits, each amplitude amount is adjusted. It is an object of the gain control to obtain a sufficient arithmetic operating precision at the time of the orthogonal transformation at the post stage when a micro signal is inputted and to reduce a phenomenon such that since quantization errors are uniformly generated in the orthogonal transformation block, they can be recognized as noises in the micro signal portion, that is, to reduce the generation of what is called a preecho.

As a method of dividing the input digital signal into a plurality of frequency bands as mentioned above, for example, there is the QMF as disclosed in R. E. Crochiere, “Digital Coding of Speech In Subbands”, Bell Syst. Tech. J., Vol. 55, No. 8, 1976.

A good result was also obtained by using the foregoing method of dividing the input signal into the frequency bands of the equal band width, for example, by using the PQF.

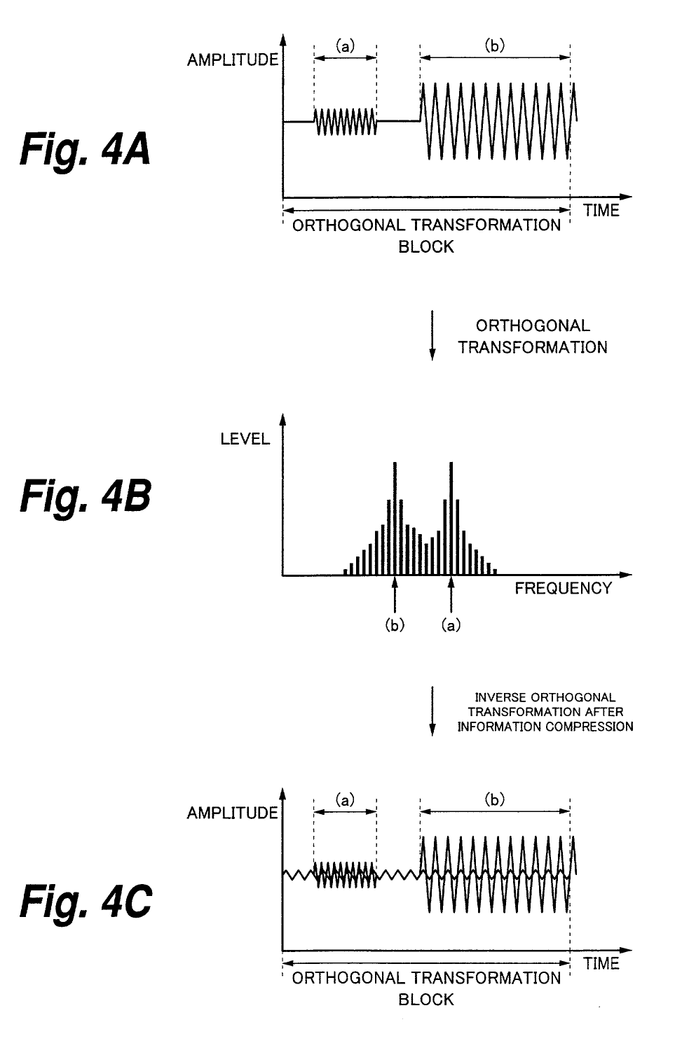

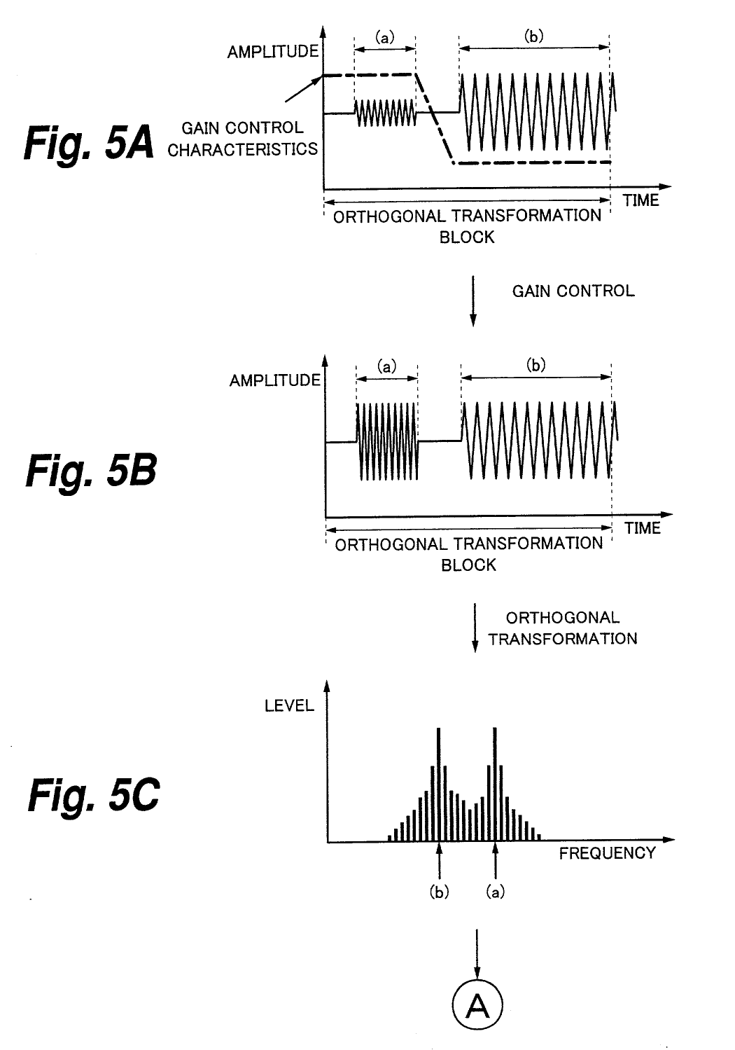

The operation of the gain control circuit will now be described with reference to FIGS. 4A to 4C and 5A to 5E. FIGS. 4A to 4C show a model in the case where the orthogonal transformation is executed without using the gain control circuit and the information compression, quantization, inverse quantization, and inverse orthogonal transformation are executed. FIG. 4A schematically shows the audio PCM signal which is inputted. Even in the case where the signal such that a large amplitude change occurred in the signal of each frequency component has been subjected to the orthogonal transformation in the orthogonal transformation block as shown in FIG. 4A, each frequency component is obtained as shown in FIG. 4B. When the information compression and the quantization are performed on the basis of this information and the inverse quantization and the inverse orthogonal transformation are further executed, the uniform quantization noises are generated in the orthogonal transformation block as shown in FIG. 4C. The quantization noises do not cause a problem in terms of the sense of hearing owing to a masking effect in the portion where the amplitude of the original signal is large as shown in a portion (b) in FIG. 4C. However, in the portion where the amplitude of the original signal is small as shown in a portion (a) in FIG. 4C, a sufficient masking effect cannot be obtained and a case where such a portion is recognized as auditory noises occurs.

FIGS. 5A to 5E, therefore, are diagrams showing the operation of the gain control circuit in the embodiment. When the amplitude characteristics of the input signal are controlled by gain control characteristics shown in FIG. 5A with respect to an input signal shown in FIG. 5A, the audio PCM signal having amplitude characteristics of a small change in an orthogonal transformation block as shown in FIG. 5B is obtained. Frequency distribution shown in FIG. 5C is obtained by orthogonally transforming the audio PCM signal. When the information compression and the quantization are performed on the basis of this information and the inverse quantization and the inverse orthogonal transformation are further executed, the uniform quantization noises are generated in a orthogonal transformation block as shown in FIG. 5D in a manner similar to the quantization noises shown in FIG. 4C. Subsequently, when the amplitude characteristics are controlled by the characteristics opposite to the gain control characteristics shown in FIG. 5A with respect to the amplitude shown in FIG. 5D, the amplitude is suppressed in the portion (a) in FIG. 5E where the amplitude is small in the original signal as shown in FIG. 5E. Thus, the level of the quantization noises also decrease and a larger masking effect is obtained, so that better auditory characteristics can be obtained.

In the embodiment, the amplitude characteristics are controlled every 64 samples of the inputted audio PCM signal so as to obtain a fluctuation such that the amplitude characteristics in the orthogonal transformation block are equal to or less than a predetermined level, so that a good result is obtained.

Subsequently, in FIG. 3, the signal of the band of 16.5 kHz to 22 kHz from the gain control circuit 304 is sent to an MDCT circuit 308 as a kind of orthogonal transformation, the signal of the band of 11 kHz to 16.5 kHz from the gain control circuit 305 is sent to an MDCT circuit 309, the signal of the band of 5.5 kHz to 11 kHz from the gain control circuit 306 is sent to an MDCT circuit 310, and the signal of the band of 0 kHz to 5.5 kHz from the gain control circuit 307 is sent to an MDCT circuit 311, so that each signal is orthogonally transformed.

The gain information contrlled every frequency band in the gain control circuits 304 to 307 is outputted to an MPX circuit 317 and outputted from an output terminal 318 together with the other data.

As a foregoing orthogonal transformation, for example, there is an orthogonal transformation such that the input audio signal is divided into blocks on a predetermined unit time (frame) and a high speed Fourier transformation (FFT), a cosine transformation (DCT), a modified DCT transformation (MDCT), or the like is performed every block, thereby transforming the time base into the frequency base. The MDCT has been disclosed in J. P. Princen and A. B. Bradley, “Subband/Transform Coding Using Filter Bank Designs Based On Time Domain Aliasing Cancellation”, ICASSPA, Univ. of Surrey Royal Melbourne Inst. Of Tech., 1987.

In FIG. 3, the spectrum data on the frequency base or the MDCT coefficient data obtained by being MDCT processed by each of the MDCT circuits 308 to 311 is transmitted to adaptive bit allocation encoding circuits 313 to 316, an expansion encoder 319, and a bit distribution calculating circuit 312. The expansion encoder 319 in FIG. 3 corresponds to the expansion encoder 210 for the fundamental encoder 206 in FIG. 2, to the expansion encoder 211 for the fundamental encoder 207, to the expansion encoder 212 for the fundamental encoder 208, and to the expansion encoder 213 for the fundamental encoder 209, respectively.

On the basis of the spectrum data divided in consideration of the critical band mentioned above, in consideration of what is called a masking effect or the like, the bit distribution calculating circuit 312 obtains a masking amount of each dividing band which takes into consideration the critical band, obtains the number of allocation bits every band on the basis of an energy, a peak value, or the like of each dividing band which takes into consideration the masking amount and the critical band, and transmits them to the adaptive bit allocation encoding circuits 313 to 316, respectively. In each of the adaptive bit allocation encoding circuits 313 to 316, each spectrum data (or MDCT coefficient data) is quantized in accordance with the number of bits allocated to each band. The data encoded as mentioned above is sent to the MPX circuit 317 and expansion encoder 319.

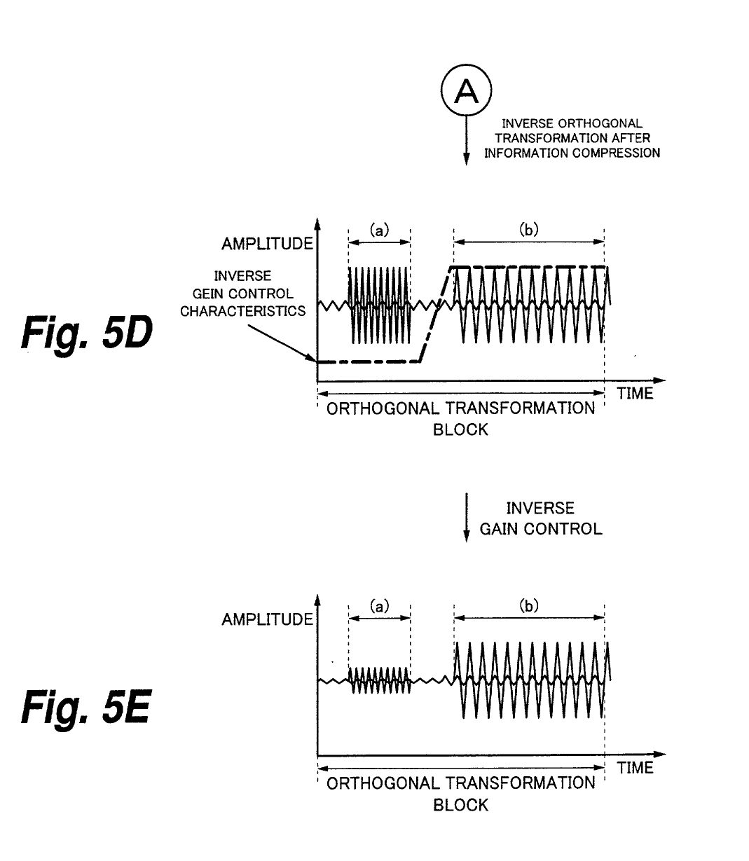

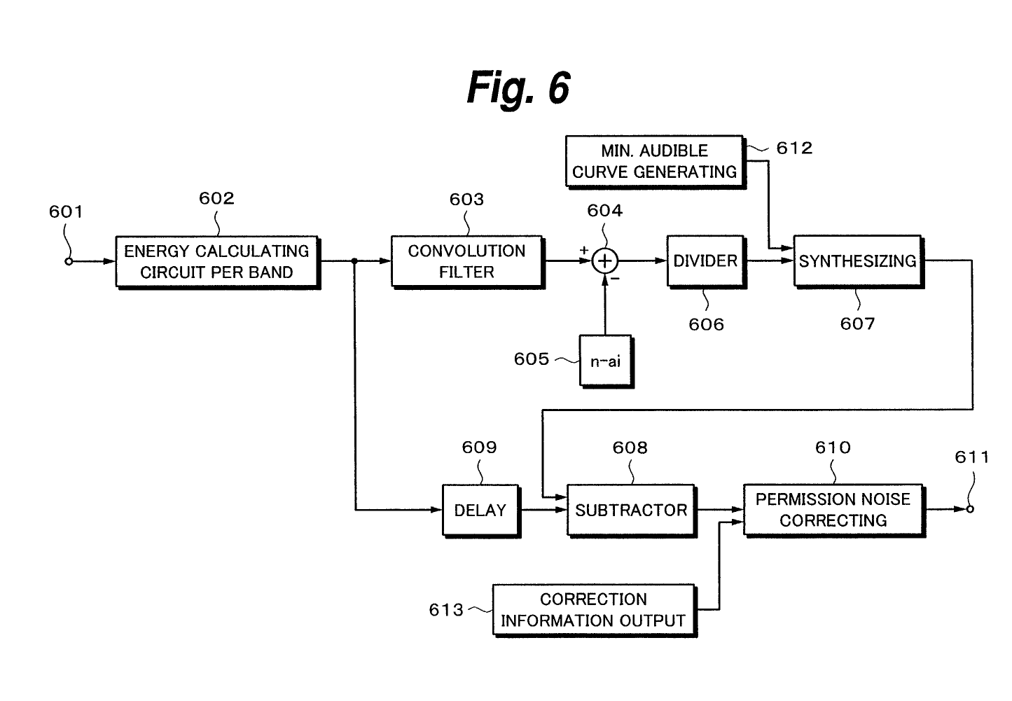

Subsequently, FIG. 6 is a block circuit diagram showing a schematic construction of one specific example of the bit distribution calculating circuit 312. The operation of the bit distribution calculating circuit will now be described with reference to FIG. 6. In FIG. 6, the spectrum data on the frequency base or the MDCT coefficient data from the MDCT circuits 308 to 311 in FIG. 3 is supplied to an input terminal 601. The input data on the frequency base is sent to an energy calculating circuit 602 of each band and an energy of each dividing band which takes into consideration the masking amount, critical band, and block floating is obtained, for example, by calculating the sum of the amplitude values in the band. In place of the energy of each band, a peak value, a mean value, or the like of the amplitude value is also used. As an output from the energy calculating circuit 602, for example, a spectrum of the sum value of each band is shown as SB in FIG. 7. However, in FIG. 7, in order to simplify the diagram, the number of dividing bands which takes into consideration the masking amount, critical band, and block floating is expressed by 12 bands (B1 to B12).

In order to considering an influence on what is called masking of the spectrum SB, a convolution process for multiplying the spectrum SB by predetermined weight functions and adding the resultant spectra is executed. For this purpose, an output of the energy calculating circuit 602 of each band, that is, each value of the spectrum SB is sent to a convolution filter circuit 603. The convolution filter circuit 603 comprises: for example, a plurality of delay elements for sequentially delaying input data; a plurality of multipliers (for example, 25 multipliers corresponding to the bands) for multiplying outputs from the delay elements by filter coefficients (weight functions); and a sum adder for obtaining the sum of outputs of the multipliers. The sum of the portions shown by broken lines in FIG. 7 is obtained by the convolution process.

A specific example of multiplication coefficients (filter coefficients) of the multipliers of the convolution filter circuit 603 is shown here. Assuming that the coefficient of a multiplier M corresponding to an arbitrary band is equal to 1, a multiplier M-1 multiplies an output of each delay element by a coefficient 0.15, a multiplier M-2 multiplies an output of each delay element by a coefficient 0.0019, a multiplier M-3 multiplies an output of each delay element by a coefficient 0.0000086, a multiplier M+1 multiplies an output of each delay element by a coefficient 0.4, a multiplier M+2 multiplies an output of each delay element by a coefficient 0.06, and a multiplier M+3 multiplies an output of each delay element by a coefficient 0.007, respectively, thereby performing the convolution process of the spectrum SB. M denotes an arbitrary integer of 1 to 25.

Subsequently, an output of the convolution filter circuit 603 is sent to a subtractor 604. The subtractor 604 obtains a level a corresponding to an allowable noise level, which will be explained hereinlater, in a convoluted region. As will be explained hereinlater, the level a corresponding to the allowable noise level (permission noise level) is a level such that a permission noise level of each of the critical bands is obtained by performing an inverse convolution process. A permission function (function for expressing the masking level) for obtaining the level a is supplied to the subtractor 604. The level a is controlled by increasing or decreasing the permission function. It is assumed that the permission function is supplied from an (n−ai) function generating circuit 605 as will be explained hereinbelow.

That is, assuming that the numbers allocated in order from the low band among the critical bands are set to “i”, the level a corresponding to the permission noise level can be obtained by the following equation (1).

α=S−(n−ai) (1)

where,

n, a: constants (a>0)

S: intensity of a bark spectrum which was subjected to the convolution process

(n−ai): permission function

In the embodiment, it is assumed that n=38 and a=1. At this time, there is no deterioration in sound quality and a good encoding can be performed.

The level a is obtained in this manner and this data is transmitted to a divider 606. The divider 606 performs an inverse convolution process to the level a in the convoluted region. Therefore, by executing the inverse convolution process, a masking spectrum is obtained from the level α. That is, this masking spectrum becomes the permission noise spectrum. Although the inverse convolution process needs complicated arithmetic operations, the inverse convolution is executed by using the simplified divider 606 in the embodiment.

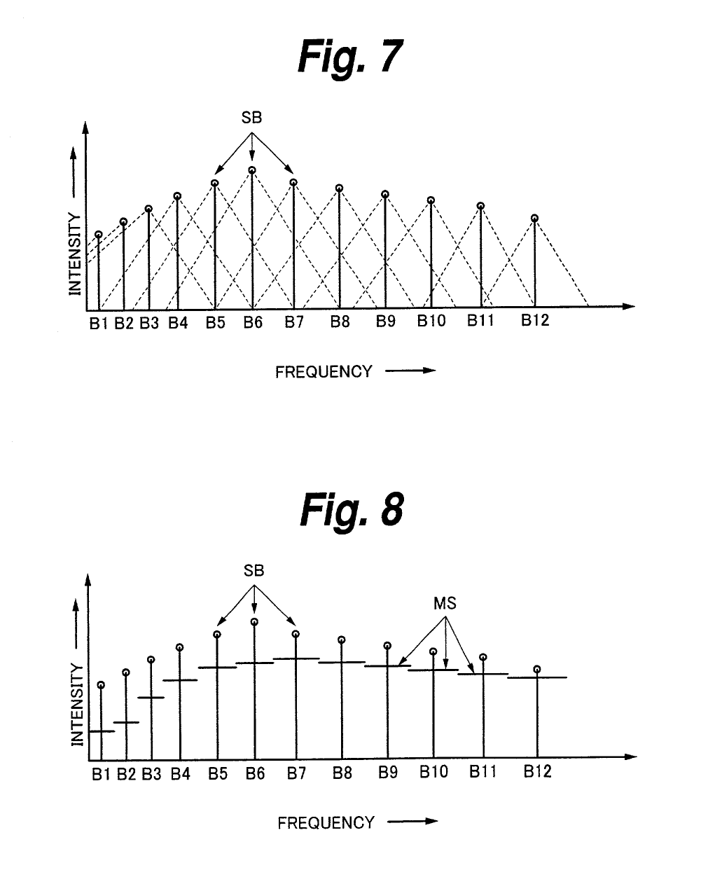

The masking spectrum is subsequently transmitted to a subtractor 608 through a synthesizing circuit 607. An output from the energy calculating circuit 602 of each band, that is, the spectrum SB is supplied to the subtractor 608 through a delay circuit 609. Therefore, since a subtraction of the masking spectrum and the spectrum SB is executed in the subtractor 608, as shown in FIG. 8, the spectrum SB at levels below the level shown by the level of the masking spectrum MS is masked.

An output from the subtractor 608 is extracted from an output terminal 611 through a permission noise correcting circuit 610 and sent to, for example, an ROM or the like (not shown) in which information indicative of the number of allocation bits has been stored. From the ROM or the like, the allocation bit number information of each band is outputted in response to the output (level of a difference between the energy of each band and an output of noise level setting means) obtained from the subtractor 608 through the permission noise correcting circuit 610. Since the allocation bit number information is sent to the adaptive bit allocation encoding circuits 313 to 316 in FIG. 3, each spectrum data on the frequency base from the MDCT circuits 308 to 311 in FIG. 3 is quantized by the number of bits allocated every band.

In brief, in the adaptive bit allocation encoding circuits 313 to 316 in FIG. 3, the spectrum data of each band is quantized by the number of bits allocated in accordance with a level of a difference between the energy of each dividing band which takes into consideration the masking amount, critical band, and block floating and the output of the noise level setting means. The delay circuit 609 in FIG. 6 is provided to delay the spectrum SB from the energy calculating circuit 602 in consideration of the delay amount in each circuit before the synthesizing circuit 607.

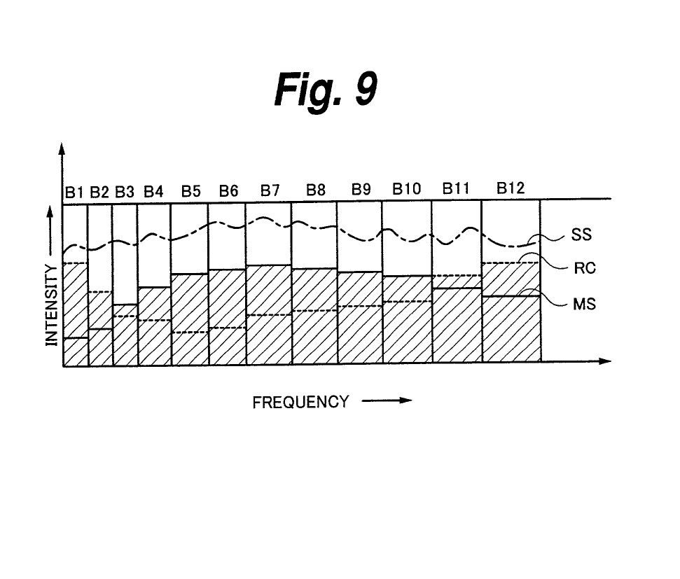

At the time of the synthesization in the synthesizing circuit 607 mentioned above, data showing what is called a minimum audible curve RC which is supplied from a minimum audible curve generating circuit 612 and indicates human auditory characteristics as shown in FIG. 9 and the masking spectrum MS can be synthesized. In the minimum audible curve, if the noise absolute level is equal to or less than the minimum audible curve, the listener cannot hear the noises. Even if the coding methods are the same, the minimum audible curve becomes different, for example, due to a difference of a reproducing volume upon reproduction. However, in an actual digital system, for example, there is not a large difference in methods of introducing music into a dynamic range of 16 bits. Therefore, for instance, assuming that the listener cannot hear the quantization noises of a frequency band near 4 kHz which can be heard most easily, it is considered that the listener cannot hear the quantization noises at levels which are equal to or less than the level of the minimum audible curve in other frequency bands. Therefore, for example, by assuming that the system is used by a method whereby the noises near 4 kHz of the word length which the system has cannot be heard as mentioned above, if the listener intends to obtain the permission noise level by synthesizing the minimum audible curve RC and the masking spectrum MS, the permission noise level in this case can be set to a level up to each portion shown by hatched regions in FIG. 9. In the embodiment, the level of 4 kHz of the minimum audible curve is matched with, for example, the lowest level corresponding to 20 bits. FIG. 9 also shows a signal spectrum SS.

In the permission noise correcting circuit 610, on the basis of information of, for example, an equal loudness curve which is sent from a correction information output circuit 613, the permission noise level in the output from the subtractor 608 is corrected and transmitted to the MPX circuit 317 in FIG. 3 through the output terminal 611. The equal loudness curve is a characteristics curve regarding the human auditory characteristics. For example, it is obtained by a method whereby a sound pressure of the sound at each frequency which is heard at the same sound volume as that of the pure sound of 1 kHz is obtained and the obtained sound pressures are coupled by a curve. The equal loudness curve is also called an equal sensitivity curve of the loudness. The equal loudness curve is drawn by almost the same curve as the minimum audible curve RC shown in FIG. 9. In the equal loudness curve, for example, even if the sound pressure at a frequency near 4 kHz is reduced by 8 to 10 dB than that at 1 kHz, the sound near 4 kHz is heard at almost the same sound level as that at 1 kHz. On the contrary, at a frequency near 50 Hz, unless the sound pressure is higher than that at 1 kHz by about 15 dB, the sound cannot be heard at the same sound level. Therefore, it will be understood that, preferably, the noises (permission noise level) exceeding the level of the minimum audible curve has the frequency characteristics given by the curve according to the equal loudness curve. From this principle, it will be understood that the process for correcting the permission noise level in consideration of the equal loudness curve is adapted to the human auditory characteristics.

Further, in the correction information output circuit 613, the permission noise level is corrected on the basis of the information of the errors between the detection output of the output information amount (data amount) upon quantization in the adaptive bit allocation encoding circuits 313 to 316 in FIG. 3 and the target value of the bit rate of the final encoding data. This is because there is a case where the total number of bits obtained by preliminarily performing the temporary adaptive bit allocation to all of the bit allocation unit blocks has an error for the predetermined number of bits (target value) which is determined by the bit rate of the final encoding output data, and the bit allocation is performed again so as to set the error amount to 0. That is, when the total number of allocation bits is smaller than the target value, the bits of the number as many as the difference are distributed to each unit block so as to be added. When the total number of allocation bits is larger than the target value, the bits of the number as many as the difference are distributed to each unit block so as to be reduced.

In order to perform the above operation, the error between the total number of allocation bits and the target value is detected and the correction information output circuit 613 outputs correction data for correcting each allocation bit number in accordance with the error data. In the case where the error data indicates a lack of bits, a case where the data amount is larger than the target value by using many bits per unit block can be considered. In the case where the error data indicates a surplus of bits, it is sufficient that the number of bits per unit block is small and a case where the data amount is smaller than the target value is considered. Therefore, the data of the correction value for correcting the permission noise level in the output from the subtractor 608 on the basis of, for example, the information data of the equal loudness curve is outputted from the correction information output circuit 613 in accordance with the error data. Since the correction value as mentioned above is transmitted to the permission noise correcting circuit 610, the permission noise level from the subtractor 608 is corrected. In the system as described above, the data obtained by processing the orthogonal transformation output spectrum by the sub-information is obtained as main information, a scale factor showing a state of the block floating and the word length are obtained as sub-information, and those main information and sub-information are sent from the encoder to the decoder.

Although the embodiment has been described above on the assumption that a frequency band which is inputted to the bit distribution calculating circuit is set to a range of 0 to 22 kHz, that is, what is called an audible frequency band, it is desirable to optimize each bit distribution calculating circuit every frequency band. In the embodiment, in the band of 22 kHz or higher, the band is divided into 25 bands of the equal band width, the curve which is generated by the minimum audible curve generating circuit 612 in FIG. 6 in the band is assumed to be the curve which is simply inversely proportional to the frequency, and the signal process is executed. To simplify the apparatus, even if the bit distribution calculating circuit in the band of 0 to 22 kHz, that is, what is called an audible frequency band is used in common even in another band, a similar effect is obtained.

Referring again to FIG. 3, the expansion encoder 319 corresponds to the expansion encoders 210 to 213 in FIG. 2 and is a circuit for improving the word length (S/N) of the present signal processing apparatus by compressing and quantizing again the quantization error of the data which was compressed and quantized by the fundamental encoders 206 to 209.

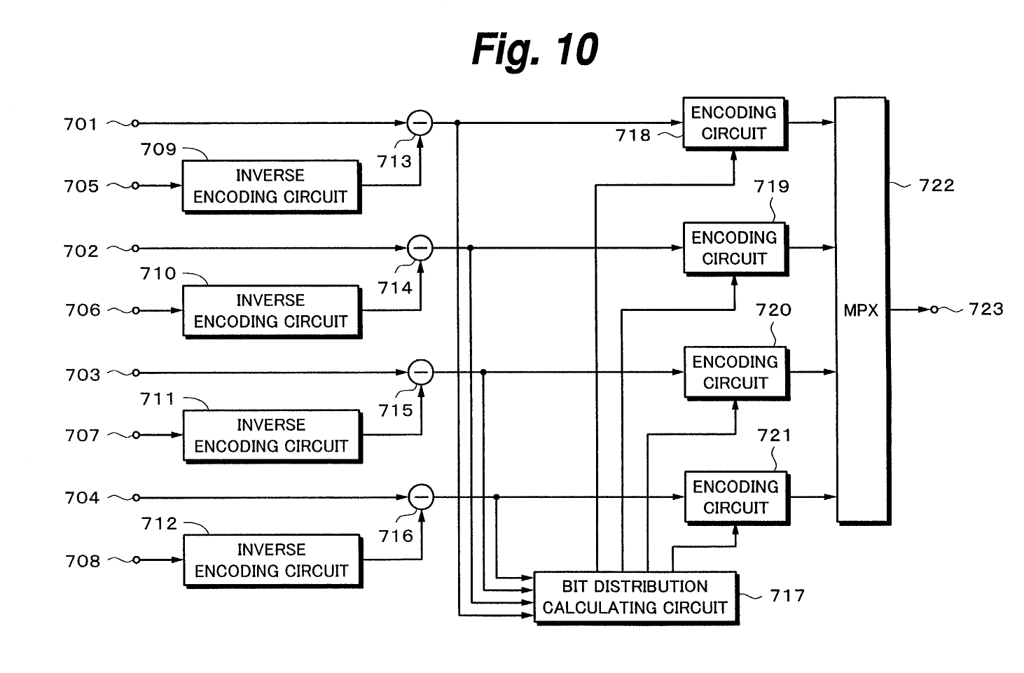

FIG. 10 is a block circuit diagram showing a schematic construction of a specific example of the expansion encoder 319 in FIG. 3. The operation of the expansion encoder will now be described with reference to FIG. 10. In FIG. 10, an input terminal 701 is connected to the output of the MDCT circuit 308 in FIG. 3. Similarly, an input terminal 702 is connected to the output of the MDCT circuit 309 in FIG. 3, an input terminal 703 is connected to the output of the MDCT circuit 310 in FIG. 3, and an input terminal 704 is connected to the output of the MDCT circuit 311 in FIG. 3. The spectrum data (or MDCT coefficient data) is supplied to each of the input terminals 701 to 704. An input terminal 705 is connected to the output of the adaptive bit allocation encoding circuit 313 in FIG. 3. Similarly, an input terminal 706 is connected to the output of the adaptive bit allocation encoding circuit 314 in FIG. 3, an input terminal 707 is connected to the output of the adaptive bit allocation encoding circuit 315 in FIG. 3, and an input terminal 708 is connected to the output of the adaptive bit allocation encoding circuit 316 in FIG. 3. The signal which was compressed and quantized in the fundamental encoder shown in FIG. 3 is inputted to each of the input terminals 705 to 708.

The compressed and quantized signal inputted from the input terminal 705 is inputted to an inverse encoding circuit 709. Similarly, the signal inputted from the input terminal 706 is inputted to an inverse encoding circuit 710, the signal inputted from the input terminal 707 is inputted to an inverse encoding circuit 711, and the signal inputted from the input terminal 708 is inputted to an inverse encoding circuit 712, respectively. In each of the inverse encoding circuits 709 to 712, a process for returning the quantized and encoded data to the spectrum data (or MDCT coefficient data) is executed. An output of the inverse encoding circuit 709 is sent to a subtracting circuit 713, an output of the inverse encoding circuit 710 is sent to a subtracting circuit 714, an output of the inverse encoding circuit 711 is sent to a subtracting circuit 715, and an output of the inverse encoding circuit 712 is sent to a subtracting circuit 716, respectively.

In the subtracting circuits 713 to 716, the spectrum data (or MDCT coefficient data) of each band outputted from the inverse encoding circuits 709 to 712 is subtracted from the spectrum data (or MDCT coefficient data) of each band of the MDCT circuits 308 to 311 in FIG. 3 inputted from the input terminals 701 to 704, respectively. That is, as results of the subtraction, errors (quantization errors) of the signals encoded by the adaptive bit allocation encoding circuits 313 to 316 in FIG. 3 are obtained. The error obtained by the subtracting circuit 713 is sent to an encoding circuit 718, the error obtained by the subtracting circuit 714 is sent to an encoding circuit 719, the error obtained by the subtracting circuit 715 is sent to an encoding circuit 720, and the error obtained by the subtracting circuit 716 is sent to an encoding circuit 721. Those errors are also sent to a bit distribution calculating circuit 717 for quantizing and encoding again.

The bit distribution calculating circuit 717 is a circuit for deciding distribution of the bits for reencoding the errors which have already been obtained and is substantially equivalent to the bit distribution calculating circuit 312 in FIG. 3. That is, it is a circuit which is substantially equivalent to that shown in FIG. 6. In the embodiment, in the bit distribution calculating circuit 717 in FIG. 10, the curve which is outputted from the minimum audible curve generating circuit 612 in FIG. 2 is set to a flat curve, the bit distribution is determined so as to obtain uniform quantization errors which do not depend on the energy and frequency of each dividing band, and it is sent to the encoding circuits 718 to 721. In the encoding circuits 718 to 721, each error (quantization error) is quantized and encoded again in accordance with the number of bits allocated by the bit distribution calculating circuit 717 every band. The data encoded as mentioned above is sent to an MPX circuit 722. The encoding data of the respective bands is multiplexed and outputted from an output terminal 723, that is, from an output terminal 320 in FIG. 3.

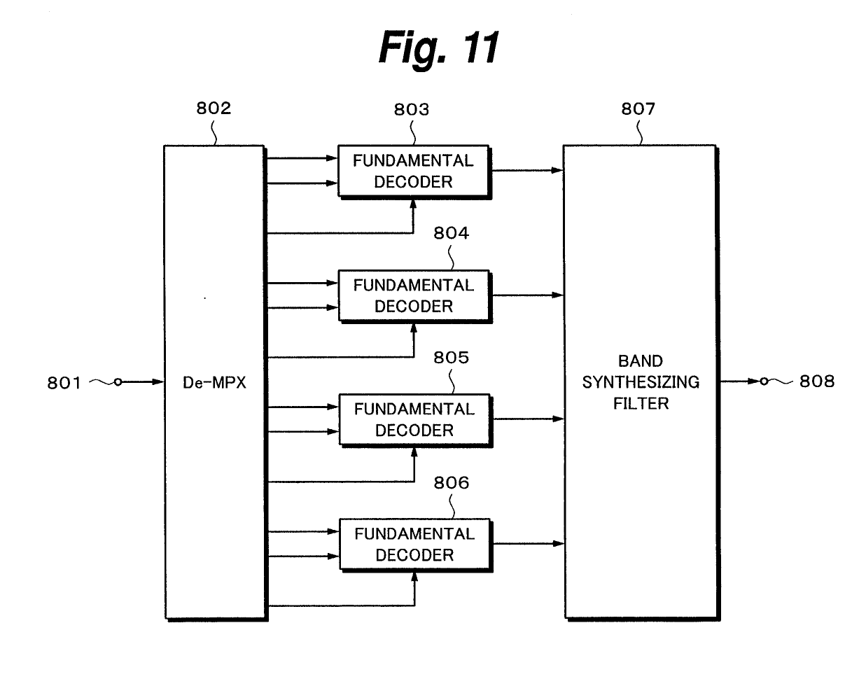

FIG. 11 shows a decoding circuit for decoding again the signal of the ATC decoder 73 in FIG. 1, that is, the signal which was high-efficient encoded as mentioned above. The compressed, quantized, and multiplexed information of each band is inputted to an input terminal 801. The multiplexed signal inputted from the input terminal 801 is sent to a De-MPX (demultiplexer) circuit 802, separated into a fundamental bit stream, an expansion bit stream, and gain information every band, and inputted to fundamental decoders 803 to 806. In the fundamental decoders 803 to 806, the spectrum data (or MDCT coefficient data) on the frequency band inputted every band is subjected to an inverse quantization, an inverse orthogonal transformation, an inverse gain control, and the like, converted into amplitude data on the time base, and outputted to a band synthesizing filter 807. In the band synthesizing filter 807, a band of 66.15 kHz to 88.2 kHz outputted from the fundamental decoder 803, a band of 44.1 kHz to 66.15 kHz outputted from the fundamental decoder 804, a band of 22.05 kHz to 44.1 kHz outputted from the fundamental decoder 805, and a band of 0 kHz to 22.05 kHz outputted from the fundamental decoder 806 are synthesized. A synthesized band is outputted as an audio PCM signal of 0 to 88.2 kHz to an output terminal 808.

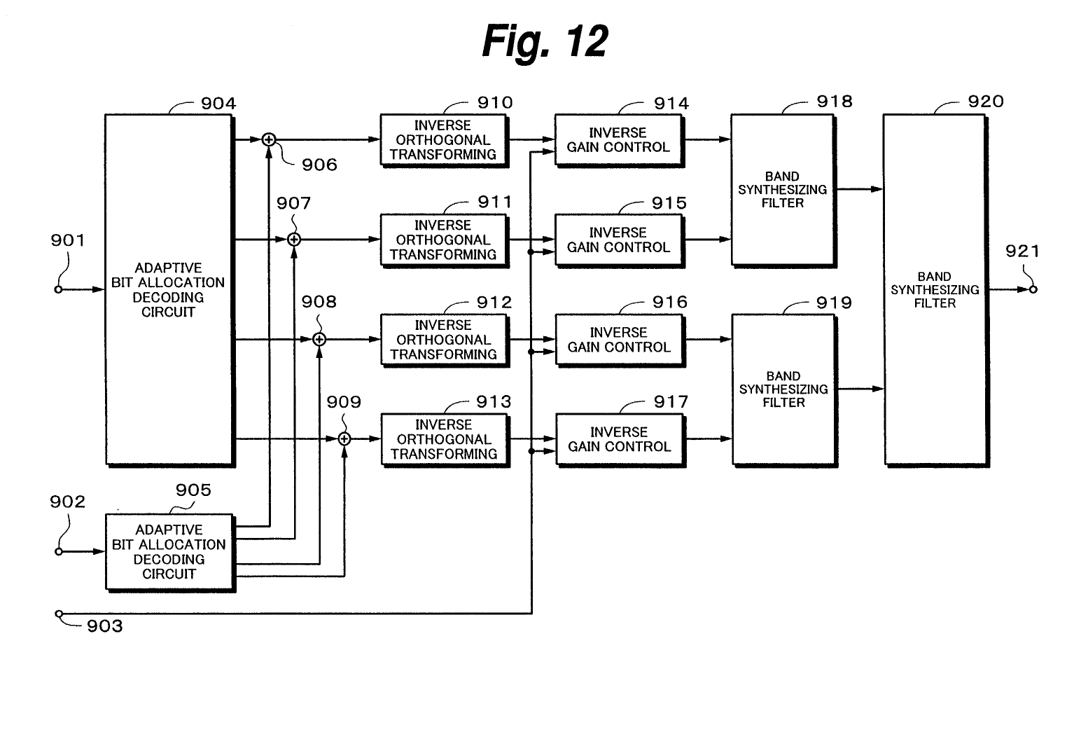

FIG. 12 shows a specific circuit of the fundamental decoders 803 to 806 in FIG. 11. The fundamental bit stream is inputted from an input terminal 901, that is, the data equivalent to the output signals of the adaptive bit allocation encoding circuits 313 to 316 in FIG. 3 is inputted and sent to an adaptive bit allocation decoding circuit 904. The expansion bit stream is inputted from an input terminal 902, that is, the data equivalent to the output signals of the encoding circuits 718 to 721 in FIG. 10 is inputted and sent to an adaptive bit allocation decoding circuit 905. Further, the gain information is inputted from an input terminal 903, that is, the data equivalent to the output signals of the gain control circuits 304 to 307 in FIG. 3 is inputted and sent to inverse gain control circuits 914 to 917. In the adaptive bit allocation decoding circuit 904, the bit allocation is cancelled by using the adaptive bit allocation information and an inverse quantization is performed, thereby restoring the spectrum data (or MDCT coefficient data) from the expansion bit stream and outputted to adding circuits 906 to 909 of each band. Further, in the adaptive bit allocation decoding circuit 905, the bit allocation is cancelled by using the adaptive bit allocation information and an inverse quantization is performed, thereby restoring the spectrum data (or MDCT coefficient data) from the fundamental bit stream and outputted to the adding circuits 906 to 909 of each band. In the adding circuits 906 to 909, for example, in the band of 0 kHz to 22.05 kHz, the spectrum data (or MDCT coefficient data) obtained from the fundamental bit stream and the spectrum data (or MDCT coefficient data) obtained from the expansion bit stream are added every band of 0 kHz to 5.5 kHz, 5.5 kHz to 11 kHz, 11 kHz to 16.5 kHz, and 16.5 kHz to 22.05 kHz and addition data is outputted to inverse orthogonal transforming (IMDCT) circuits 910 to 913, respectively.

Subsequently, in the inverse orthogonal transforming circuits 910 to 913, the signals on the frequency band is transformed into the signals on the time base. With respect to the signals on the time base of those partial bands, the inherent amplitudes are restored in the inverse gain control circuits 914 to 917 on the basis of the gain information inputted from the input terminal 903. Outputs of the inverse gain control circuits 914 and 915 are sent to a band synthesizing filter (IQMF) circuit 918, and outputs of the inverse gain control circuits 916 and 917 are sent to a band synthesizing filter circuit 919, respectively. In the band synthesizing filter circuit 918, in the band on the upper side, for example, in the band of 0 kHz to 22.05 kHz among the four divided bands, the signals on the time base of the band of 11 kHz to 16.5 kHz and the band of 16.5 kHz to 22.05 kHz are synthesized and outputted to a band synthesizing filter circuit 920. Similarly, in the band synthesizing filter circuit 919, in the band on the lower side, for example, in the band of 0 kHz to 22.05 kHz among the four divided bands, the signals on the time base of the band of 0 kHz to 5.5 kHz and the band of 5.5 kHz to 11 kHz are synthesized and outputted to the band synthesizing filter circuit 920. In the band synthesizing filter circuit 920, in the band which has already been synthesized, for example, in the band of 0 kHz to 22.05 kHz, the signals on the time base of the band of 0 kHz to 11 kHz and the band of 11 kHz to 22.05 kHz are synthesized and decoded to a whole band signal and outputted from an output terminal 921.

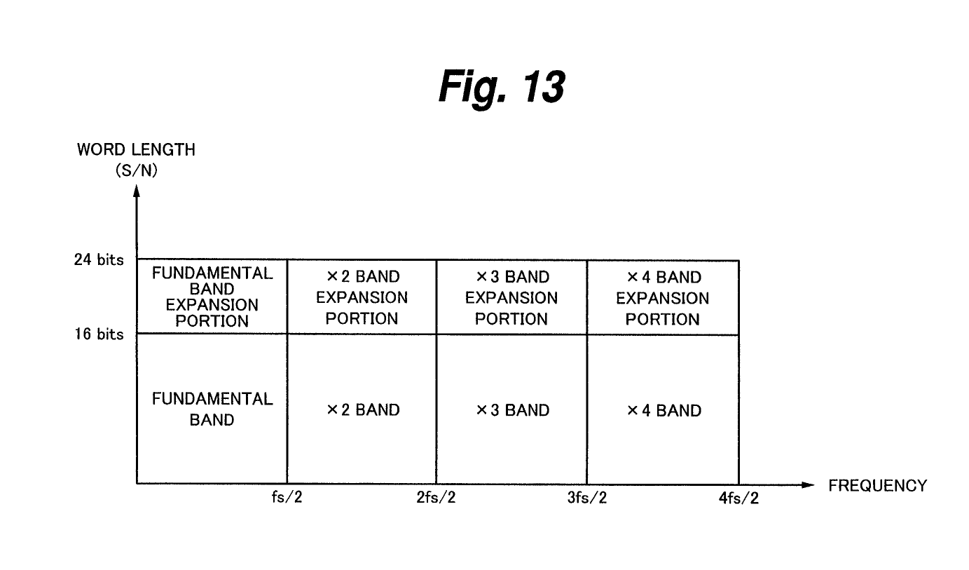

The operation in the invention will now be described with reference to FIG. 13 and subsequent drawings. FIG. 13 is a diagram showing a concept of the compression bit stream which is outputted from a signal compressing apparatus or an information compressing method according to the embodiment. The bit stream is divided into a fundamental band, a ×2 band, a ×3 band, and a ×4 band every frequency band. Further, as a portion corresponding to the word length of the input signal, for example, it is divided into a fundamental portion of up to 16 bits and an expansion portion in a range from 16 bits to 24 bits. The bit stream is constructed by eight portions by a combination of them.

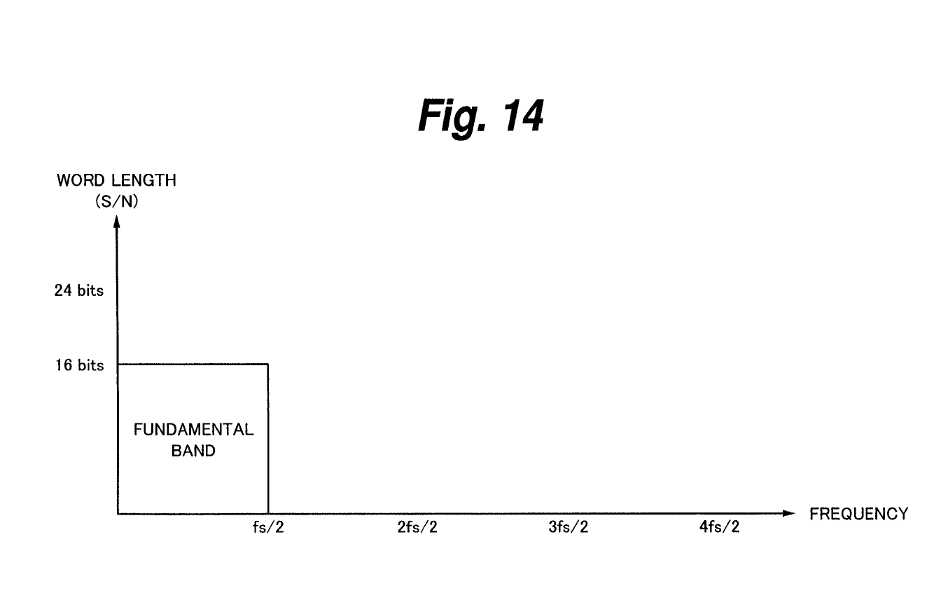

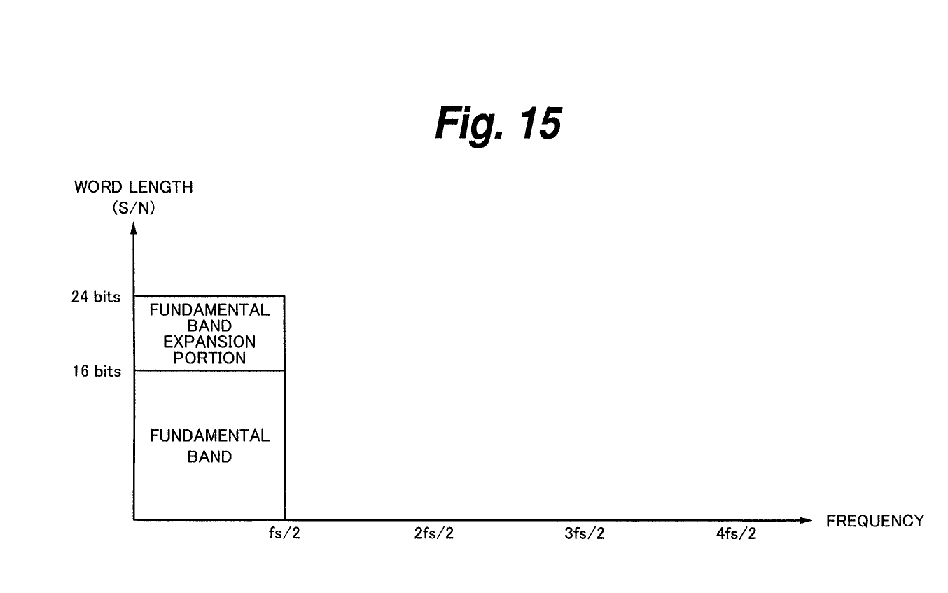

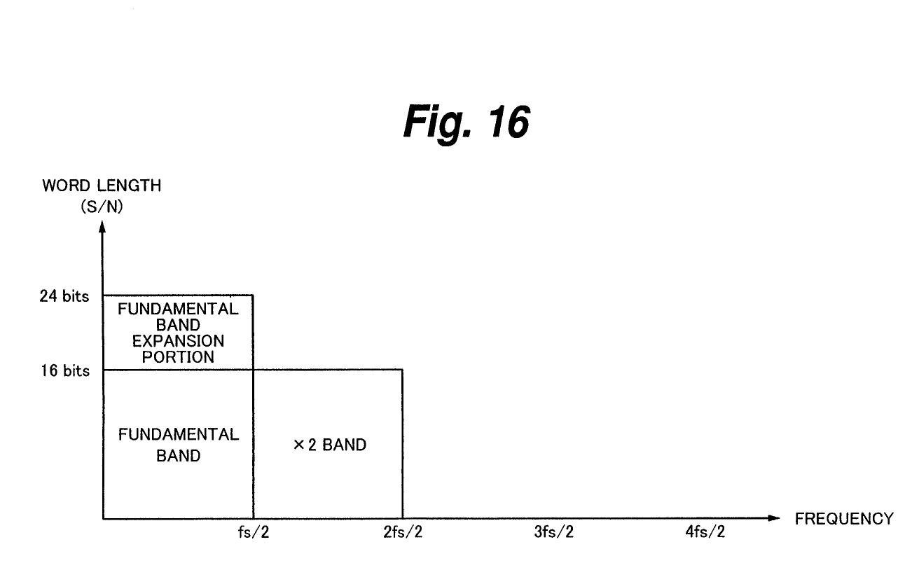

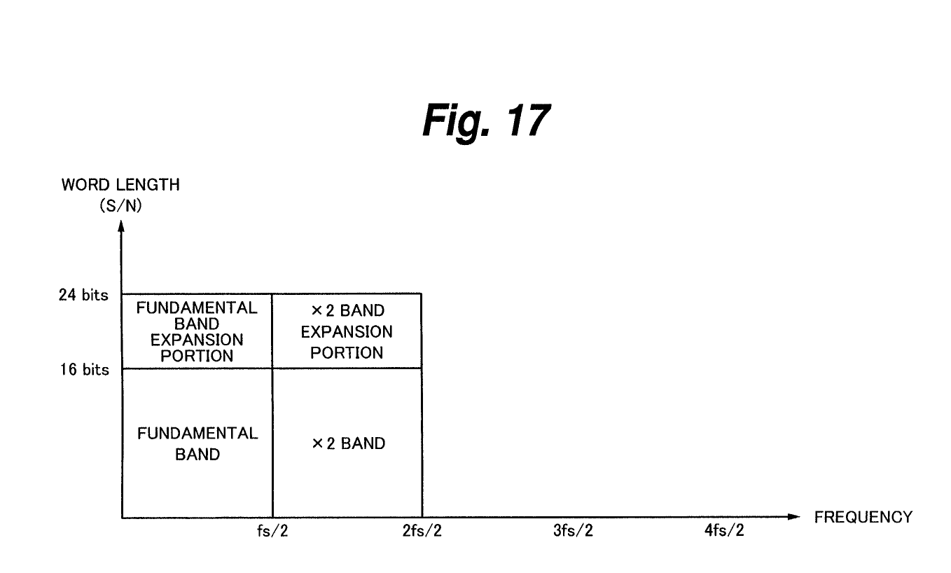

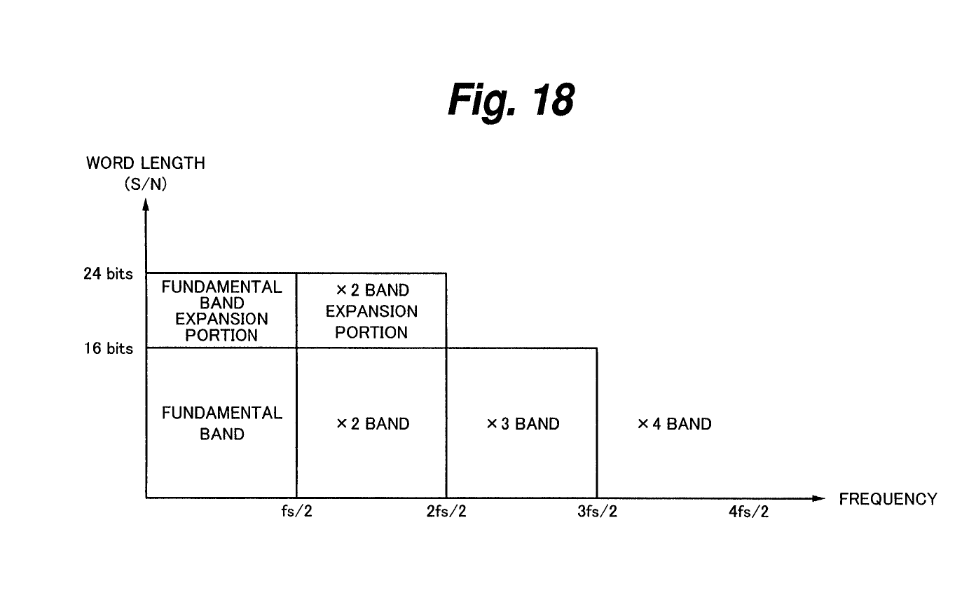

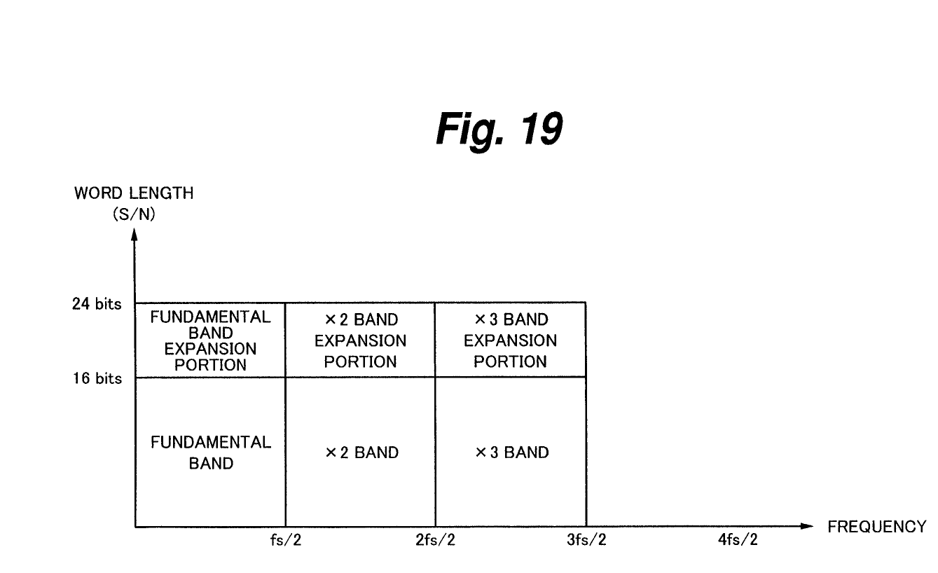

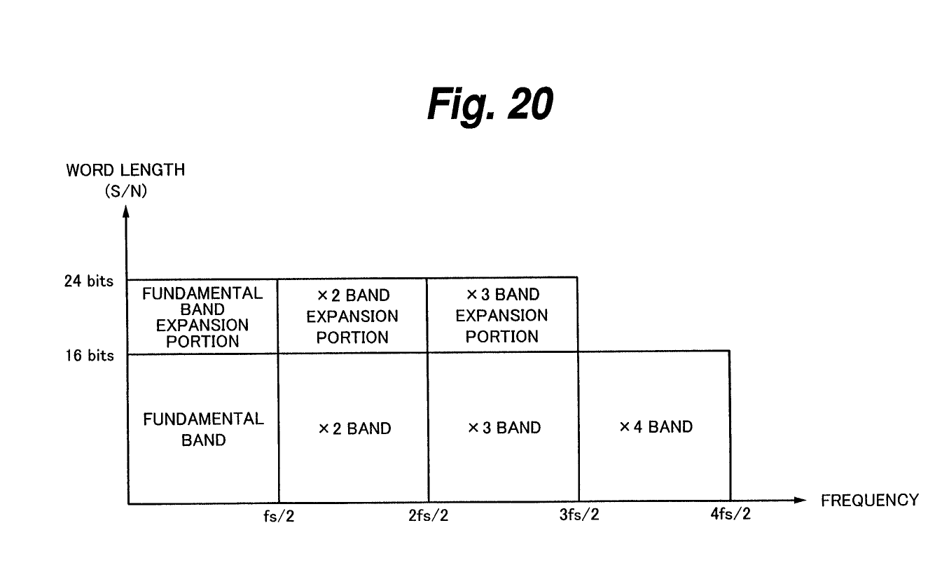

According to a signal decompressing apparatus or an information decompressing method according to the embodiment, if at least the fundamental portion of one frequency band exists among the above eight portions, the information can be decompressed. That is, the outputs of the fundamental decoders 803 to 805 in FIG. 11 are “0” and in FIG. 13 corresponding to the fundamental decoder 806, even in a state where the output of the adaptive bit allocation decoding circuit 905 is equal to “0”, the information of the fundamental band adapted to the word length of 16 bits as shown in FIG. 14 can be decompressed. Similarly, FIG. 15 shows an example of decompression of information of the fundamental band adapted to the word length of 24 bits. FIG. 16 shows an example of decompression of information of the fundamental band adapted to the word length of 24 bits and the ×2 band adapted to the word length of 16 bits. Hereinbelow, FIGS. 17 to 20 show examples in the case where the frequency bands and the word length which are sequentially decompressed are magnified. As will be also obviously understood from those examples, according to the invention, not only the information having the same word length and band as those in FIG. 13 can be decompressed from the compression bit stream as shown in FIG. 13 but also the information having word lengths and bands as shown in FIGS. 14 to 20 can be decompressed from the same compression bit stream due to a circumstance of only the signal decompressing apparatus or a signal decompressing method.

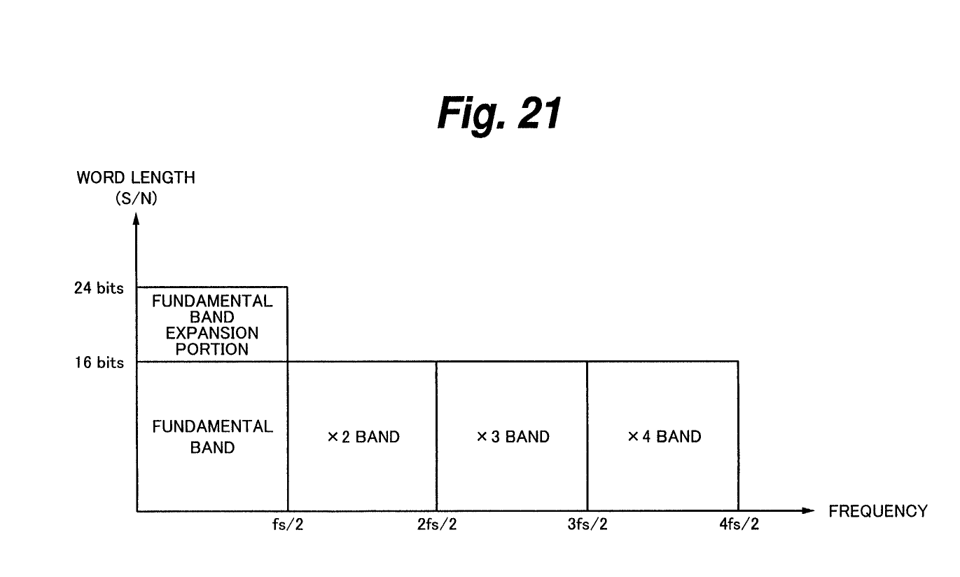

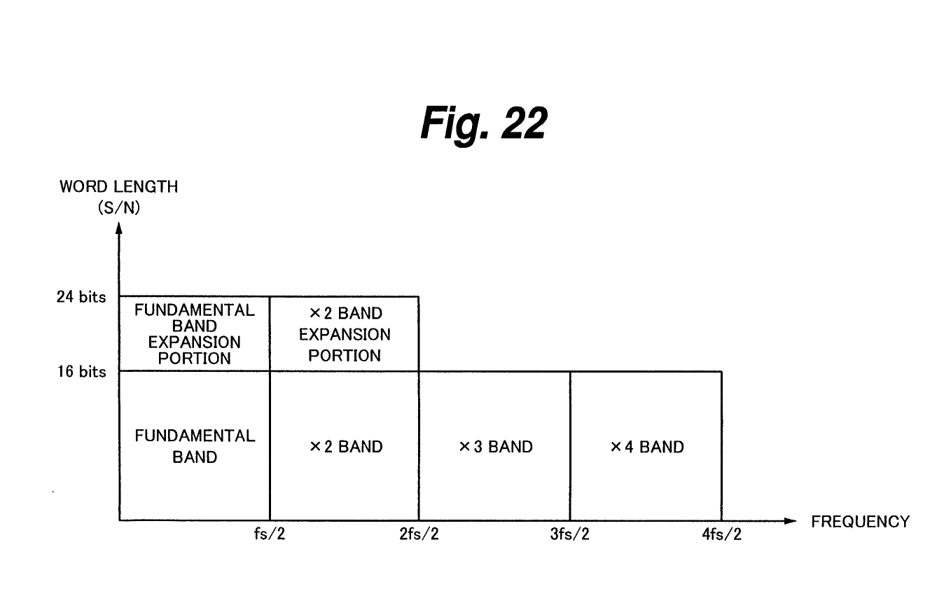

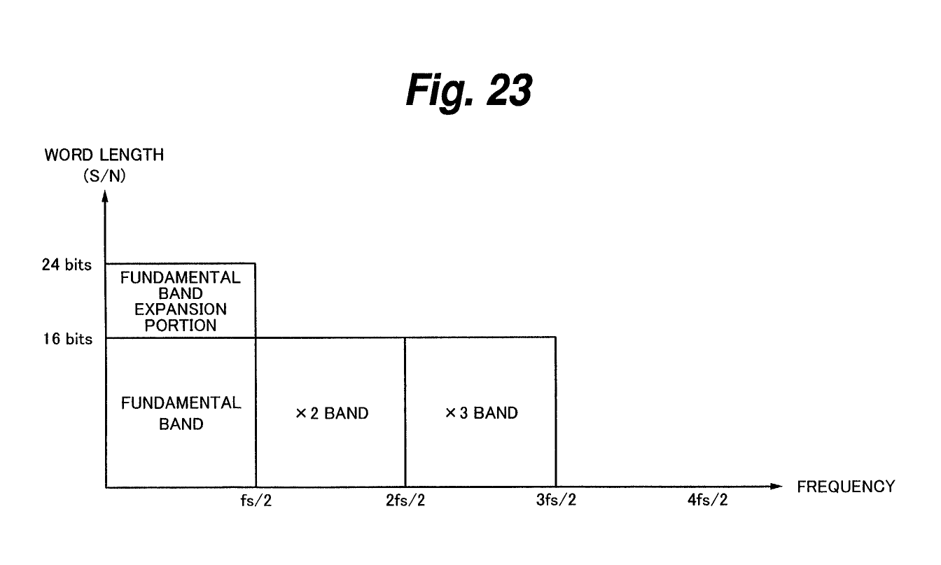

Besides, it will be obviously understood that the decompression of information can be performed even in the case where the word lengths and decompressing bands are not expanded as shown in FIGS. 21 to 23 and decompression of information due to a combination of the word lengths and decompressing frequency bands according to the combination of the eight portions in FIG. 13 other than the examples shown in FIGS. 13 to 23 is possible.

As mentioned above, as for the selectivity, not only in the signal decompressing apparatus or information decompressing method but also in the signal compressing apparatus or information compressing method, as shown in FIGS. 13 to 23, the information can be easily outputted in a form of the compression bit stream in the embodiment. In this case, it will be obviously understood that the compression bit stream outputted by the signal compressing apparatus or information decompressing method is set to an upper limit of the amount of information which can be decompressed.

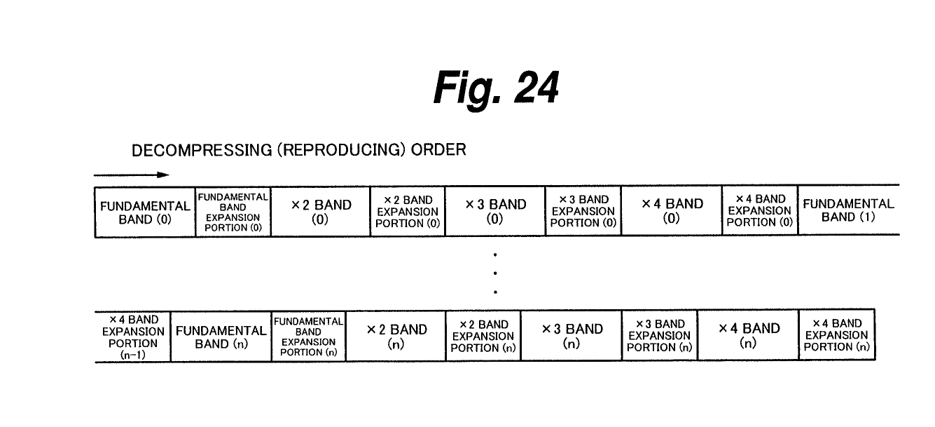

A feature of the compression bit stream which is recorded on the magnetooptic disc 1 in FIG. 1 will now be described with reference to FIG. 24 and subsequent drawings. In the signal compressing apparatus or information decompressing method in the embodiment, it has a plurality of recording forms according to the combination of the word lengths and frequency bands mentioned above. FIG. 24 shows a state where the compression bit stream shown in FIG. 13 has been developed and recorded onto the same track. When such a recording system is selected, it is convenient in case of decompressing the signals with respect to all of the word lengths and frequency bands and the apparatus can be realized by the minimum construction. On the other hand, in case of decompressing only the fundamental band, for example, in order to extract only the portion in which the fundamental band has been recorded, the control of the magnetooptic disc 1 in FIG. 1, that is, the operations of the servo control circuit 56 and system controller 57 in FIG. 1 become complicated or, there is a tendency such that the apparatus for decompression becomes complicated because, after the information was recorded into the memory 72 in FIG. 1, the necessary portions are extracted, or the like. However, in case of recording the information onto the magnetooptic disc as shown in the embodiment, a relatively good result was obtained.

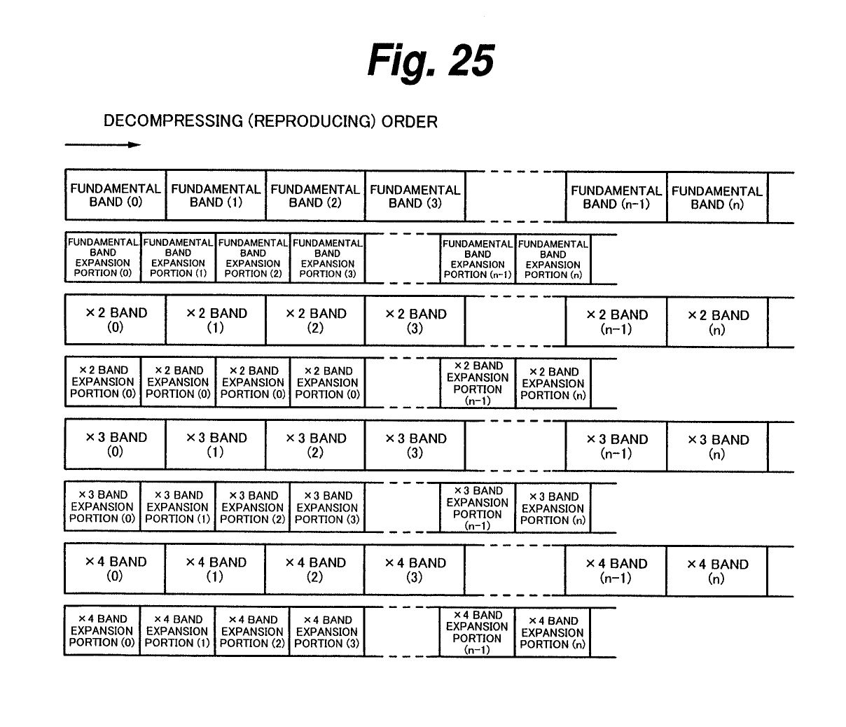

FIG. 25 shows a state where information has been developed and recorded onto other tracks every fundamental portion and expansion portion of each band. In case of selecting such a recording system, it is convenient in case of decompressing the signal with respect to only the fundamental frequency band and the apparatus can be formed by the minimum construction. In case of decompressing all of the word lengths and frequency bands, for example, in order to decompress the 0th block, it is necessary to read out the data from eight tracks of the fundamental band (0), the fundamental band expansion portion (0), the ×2 band (0), the ×2 band expansion portion (0), the ×3 band (0), the ×3 band expansion portion (0), the ×4 band (0), and the ×4 band expansion portion (0), so that there is a tendency such that the apparatus for decompressing becomes complicated. However, in the recording by the semiconductor such as an IC memory, or the like, the data reading operation from the plurality of tracks as mentioned above can be easily performed.

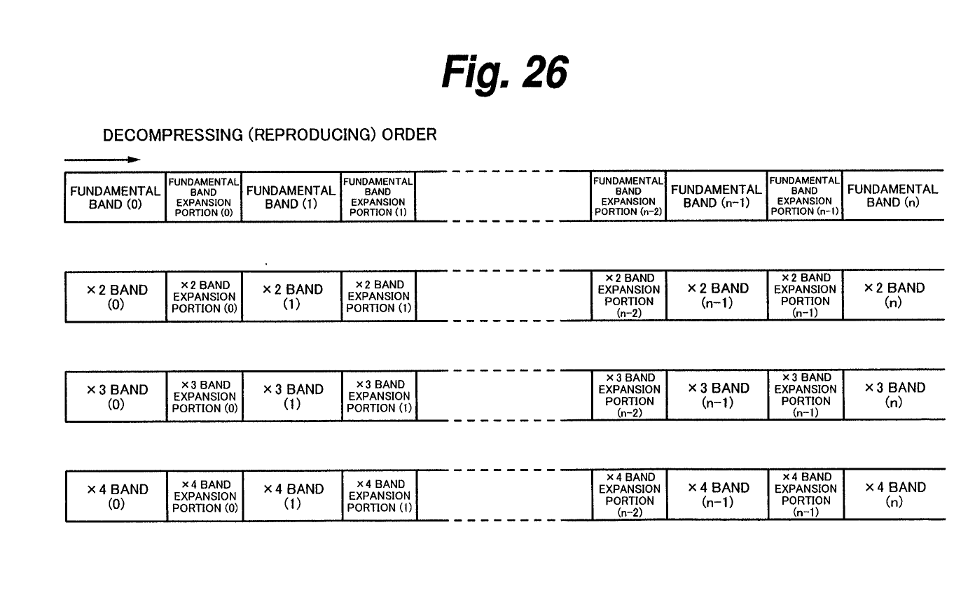

Further, FIG. 26 shows a state where the fundamental portions and the expansion portions of each band have been developed and recorded on the same track. In case of selecting such a recording system, the construction of FIG. 26 has an intermediate feature of those shown in FIGS. 24 and 25 and the information can be transmitted by using the transmission path in the case where the recording medium cannot be specified.

The invention is not limited only to the embodiment but, for example, the foregoing recording and reproducing medium and the signal compressing apparatus or decompressing apparatus and, further, the signal compressing apparatus and decompressing apparatus are not always necessary to be integrated. Those apparatuses can be also coupled by a data transfer line or an optical cable or by communication using light or a radio wave, or the like without passing through the recording media. Further, for example, the invention is not limited only to the audio PCM signal but can be also applied to a signal processing apparatus of a digital speech signal, a digital video signal, or the like.

According to the recording medium of the invention, by recording the data compressed by the digital signal processing apparatus, the recording capacity can be effectively used. The recording medium of the invention is not limited to the foregoing magnetooptic disc but can also use various recording media such as optical disc, magnetic disc, IC memory, card having the memory therein, magnetic tape, and the like.

According to each of the digital signal processing apparatuses and methods of the invention, the input signal is divided into a plurality of bands, the information amount is reduced by decimating the signal, and a plurality of fundamental encoders and expansion encoders of a relatively small scale corresponding to the divided bands are arranged in a layer manner.

The input signal of the fundamental encoders is the audio signal and as its frequency is high, a frequency width of the block where the generation of the quantization noises of at least most of the portion is controlled becomes wider. The digital signal processing apparatus and/or method of the invention has the orthogonal transforming means using the orthogonal transformation in order to divide the signal into a plurality of bands on the frequency base from the time base signal and/or the inverse orthogonal transforming means using the inverse orthogonal transformation in order to transform from a plurality of bands on the frequency base into the time base signal. At this time, upon division from the time base signal to a plurality of bands on the frequency base, it is first divided into a plurality of bands, the block comprising a plurality of samples is formed every divided band, the gain is controlled so that the amplitude becomes uniform every band, the orthogonal transformation is performed every block in each band, and the coefficient data is obtained and/or upon transformation from a plurality of bands on the frequency base into the time base signal, the inverse orthogonal transformation is performed every block in each band in order to transform from a plurality of bands on the frequency base into the time base signal, the gain is controlled so as to restore the amplitude information, the inverse orthogonal transformation outputs are synthesized, and the synthesis signal on the time base is obtained. As the signal frequency is high, the dividing frequency width in the division from the time base signal before the orthogonal transformation into a plurality of bands on the frequency base and/or the synthesizing frequency width from a plurality of bands in the synthesization from a plurality of bands on the frequency base after the inverse orthogonal transformation to the time base signal becomes wider. The quadrature mirror filter (QMF) is used for the division into the plurality of bands and/or the transformation into the signal on the time base comprising the plurality of bands. The modified discrete cosine transformation is used as an orthogonal transformation.

The recording medium of the invention records the compression data compressed by the digital signal processing apparatus or information compressing method of the invention as mentioned above.

That is, according to the digital signal processing apparatus or information compressing method of the invention, the input signal is divided into a plurality of bands and in order to compress and decompress the divided bands, the means for performing the compression and decompression of a small scale is arranged at a plurality of stages in a layer manner, so that it is possible to cope with the frequency bands in a wide range.

In the compression processing step, the error of the compression result is detected, the error is recompressed, and the data in which the error was recompressed is added, thereby enabling the compression quality to be improved.

Further, the compressed data is divisionally recorded in a layer manner and the whole or a part of the data is selectively recorded upon recording, so that the quality upon decompression of the compression data to be recorded can be selected and controlled.

In addition, the compressed data is divisionally recorded in a layer manner and the whole or a part of the data is selectively decompressed up on decompression, so that the decompression quality upon decompression can be selected.

As will be obviously understood from the above description, according to the digital signal processing apparatus or information compressing method of the invention, it is possible to efficiently cope with the compression ratios in a wide range by the single apparatus or information compressing method.

Further, according to the digital signal processing apparatus or information compressing method of the invention, the information of a wider band and higher precision can be compressed by a combination of a plurality of signal processing circuits of a smaller scale. Not only a construction is simplified in case of realizing the signal processing apparatus but also an optimum construction is obtained in case of realizing it by a DSP (Digital Signal Processor) or the like in a software manner.

Moreover, by forming the bit stream adapted to the combination of a plurality of signal processing circuits of a small scale, for example, in an apparatus in which importance is attached to the portability, a part of the compressed data can be selectively decompressed and reproduced and in an apparatus which is fixedly installed, the signal of higher quality can be compressed and decompressed, and the like by the same compression bit stream. The decompression and reproduction quality can be more easily selected when the information is compressed more flexibly and in a wider range than those in the conventional apparatus or it can be more easily selected in a decompressing apparatus.

Besides, since the bit stream itself compressed by the digital signal processing apparatus or information compressing method of the invention corresponds to a plurality of bit rates, it is possible to cope with the transmission of the information by the transmission path having various transfer rates and the recording to the recording media having different recording capacities (densities) by the same compression bit stream. There is no need to have the compression bit streams of a plurality of compression ratios in accordance with the transmission paths or recording media. Thus, the standard of the system can be easily constructed and the scale of the apparatus can be also reduced.

The present invention is not limited to the foregoing embodiment but many modifications and variations are possible within the spirit and scope of the appended claims of the invention.

What is claimed is:

1. A compression data recording apparatus for compressing a digital signal, comprising:
band dividing means for dividing an input signal into a plurality of bands; and
compressing and decompressing means for performing a compression and a decompression of a small scale for compressing and decompressing said divided bands,
wherein said compressing and decompressing means is arranged at a plurality of stages in a layer manner.

2. A compression data recording apparatus for compressing a digital signal, comprising:
error detecting means for detecting an error of a compression result in a compression processing step; and
recompressing means for recompressing said error,
wherein data in which said error was recompressed is added, thereby improving compression quality.

3. A compression data recording apparatus for compressing a digital signal, comprising:
recording means for divisionally recording compression data in a layer manner; and
selective recording means for selectively recording a whole or a part of said data upon recording,
wherein quality upon decompression of the compression data which is recorded can be selected and controlled.

4. A compression data recording and reproducing apparatus for decompressing compression data in which a digital signal has been compressed, comprising:
recording means for divisionally recording said compression data in a layer manner; and
selective decompressing means for selectively decompressing a whole or a part of the data upon decompression,
wherein decompression quality can be selected upon decompression.

5. A compression data recording method of compressing a digital signal, comprising the steps of:
dividing an input signal into a plurality of bands;
performing a compression and a decompression of a small scale for compressing and decompressing said divided bands; and
arranging the step of performing said compression and decompression of the small scale at a plurality of stages in a layer manner.

6. A compression data recording method of compressing a digital signal, comprising the steps of:
detecting an error of a compression result in a compression processing step;
recompressing said error; and
adding data in which said error was recompressed, thereby improving compression quality.

7. A compression data recording method of compressing a digital signal, comprising the steps of:
divisionally recording compression data in a layer manner;
selectively recording a whole or a part of the data upon recording; and
enabling quality upon decompression of said compression data which is recorded to be selected and controlled.

8. A compression data recording and reproducing method of decompressing compression data in which a digital signal has been compressed, comprising the steps of:
divisionally recording said compression data in a layer manner;
selectively decompressing a whole or a part of the data upon decompression; and
enabling decompression quality to be selected upon decompression.

9. A recording medium for recording compression data in which a digital signal has been compressed, wherein:
an input signal is divided into a plurality of bands; and
a step of performing a compression and a decompression of a small scale for compressing and decompressing said divided bands is arranged at a plurality of stages in a layer manner, thereby recording the formed compression data.

10. A recording medium for recording compression data in which a digital signal has been compressed, wherein:
an error of a compression result in a compression processing step is detected;
said error is recompressed; and
data in which said error was recompressed is added, thereby recording the formed compression data.

11. A recording medium for recording compression data in which a digital signal has been compressed, wherein:
the compression data is divisionally recorded in a layer manner; and
a whole or a part of the data is selectively recorded upon recording, thereby recording the formed compression data.

12. A recording medium on which compression data in which a digital signal has been compressed is recorded and said recorded compression data is decompressed, wherein:
said compression data is divisionally recorded in a layer manner upon compression; and
the formed compression data is recorded and reproduced so that a whole or a part of the data can be selectively decompressed upon decompression.
